(19) United States
(12) Patent Application Publication
(10) Pub. No.: US 2026/0134025 A1
(43) Pub. Date: May 14, 2026

(54) DOCUMENT DATA PROCESSING DEVICE, DOCUMENT DATA PROCESSING METHOD, AND STORAGE MEDIUM

(71) Applicant: NEC Platforms, Ltd., Kanagawa (JP)

(72) Inventors: Ken TONARI, Kanagawa (JP); Ryo Suzuki, Kanagawa (JP); Hinako Kimura, Kanagawa (JP); Kozue Takeda, Kanagawa (JP); Takumi Okamura, Kanagawa (JP)

(73) Assignee: NEC Platforms, Ltd., Kanagawa (JP)

(21) Appl. No.: 19/367,878

(22) Filed: Oct. 24, 2025

(30) Foreign Application Priority Data
Nov. 14, 2024 (JP) 2024-199206

(51) Int. Cl. G06F 16/35; G06F 16/334; G06F 40/194

(52) U.S. Cl. CPC G06F 16/35; G06F 16/3347; G06F 40/194

(57) ABSTRACT

A document data processing device according to an exemplary aspect of the present disclosure includes: at least one memory storing a set of instructions; and at least one processor configured to execute the set of instructions to: acquire document data including one or more items; extract a word from character string data indicated in each of the items of the document data; vectorize each of pieces of the character string data based on the word for each of the pieces of the character string data; calculate similarity between the pieces of the character string data having the same item, based on a vector associated with each of the pieces of the character string data; select a combination of the document data having a coupling relationship based on the similarity and a predetermined similarity threshold; and group, into a group, the selected combination having the coupling relationship.

This application is based upon and claims the benefit of priority from Japanese Patent Application No. 2024-199206, filed on Nov. 14, 2024, the disclosure of which is incorporated herein in its entirety by reference.

### TECHNICAL FIELD

The present disclosure relates to a document data processing device, a document data processing method, and a program.

### BACKGROUND ART

JP 2009-053743 A discloses a system that assists a system in finishing a final answer by presenting appropriate answer candidates to a question in a mail call center, and selecting and peer-reviewing some answer candidates therefrom. In order to narrow down and indicate answer candidates that are a basis of the peer review, in a technique disclosed in JP 2009-053743 A, a question sentence included in document data is vectorized using document data including a question sentence obtained in the past and an answer sentence associated with the question sentence, thereby detecting similar document data.

### SUMMARY

However, in the technique disclosed in JP 2009-053743 A, it is assumed that document data obtained in the past is classified into categories in advance. A vector representing a category is calculated as an average feature vector, and similarity of the document data is determined by comparison with the calculated average feature vector. Therefore, the technique disclosed in JP 2009-053743 A suffers from a problem that it is not possible to determine similarity between document data that are not classified in advance into categories.

On the other hand, the amount of document data including question sentences and answer sentences obtained in a contact center or a call center (hereinafter, referred to as a contact center or the like) is enormous, and it is very troublesome to classify the enormous amount of document data into categories. Therefore, there is a problem that it is desired to be able to extract document data having similarity by determining the similarity between the document data even if the document data is not classified into categories in advance.

An object of the present disclosure is to provide a document data processing device, a document data processing method, and a program that solve the above-described problems.

A document data processing device according to one aspect of the present disclosure includes acquisition means for acquiring document data including one or more items, word extraction means for extracting a word from character string data indicated in the item of the document data, vectorization means for vectorizing each piece of the character string data based on the word for each piece of the character string data, similarity calculation means for calculating similarity between the pieces of the character string data having the same item, based on a vector associated with each piece of the character string data, and grouping means for selecting the document data having a direct and indirect coupling relationship based on the similarity and a predetermined similarity threshold, and grouping each of combinations having the coupling relationship to be selected.

A document data processing method according to one aspect of the present disclosure includes acquiring document data including one or more items, extracting a word from character string data indicated in the item of the acquired document data, vectorizing each piece of the character string data based on the word for each piece of the extracted character string data, calculating similarity between the pieces of the character string data having the same item, based on a vector associated with each piece of the character string data, and selecting the document data having a direct and indirect coupling relationship based on the calculated similarity and a predetermined similarity threshold, and grouping each of combinations having the selected coupling relationship.

A program according to one aspect of the present disclosure causes a computer to function as acquisition means for acquiring document data including one or more items, word extraction means for extracting a word from character string data indicated in the item of the document data, vectorization means for vectorizing each piece of the character string data based on the word for each piece of the character string data, similarity calculation means for calculating similarity between the pieces of the character string data having the same item, based on a vector associated with each piece of the character string data, and grouping means for selecting the document data having a direct and indirect coupling relationship based on the similarity and a predetermined similarity threshold, and grouping each of combinations having the coupling relationship to be selected.

According to the above aspect, even if document data is not classified into categories in advance, similarity between the document data can be determined, and the document data having similarity can be extracted.

### BRIEF DESCRIPTION OF THE DRAWINGS

FIG. 1 is a block diagram illustrating an example of a configuration of a document data processing device according to the present disclosure;

FIG. 2 is a diagram illustrating an example of interaction data according to the present disclosure;

FIG. 3 is a diagram illustrating an example of a procedure of word extraction by a word extraction unit according to the present disclosure;

FIG. 4 is a diagram illustrating an example of community detection by a community detection unit according to the present disclosure;

FIG. 5 is a flowchart illustrating an example of a flow of processing by the document data processing device according to the present disclosure;

FIG. 6 is a diagram illustrating an example of vector data generated by a vectorization unit according to the present disclosure;

FIG. 7 is a diagram illustrating combinations of interaction data to be subjected to similarity calculation according to the present disclosure;

FIG. 8 is a diagram illustrating an example of a procedure of similarity calculation by a similarity calculation unit according to the present disclosure;

FIG. 9 is a diagram illustrating an example of a transitivity-based group according to the present disclosure;

FIG. 10 is a diagram illustrating an example of affiliated group data according to the present disclosure;

FIG. 11 is a diagram illustrating an example of interaction data according to the present disclosure;

FIG. 12 is a diagram illustrating an example of group representative interaction data according to the present disclosure;

FIG. 13 is a diagram illustrating an example of interaction data compressed by the group representative interaction data according to the present disclosure;

FIG. 14 is a diagram illustrating an example of a procedure of contribution degree calculation by a group feature analysis unit according to the present disclosure;

FIG. 15 is a diagram illustrating an example of an analysis result displayed on a screen of an output device by a group feature analysis unit according to the present disclosure;

FIG. 16 is a block diagram illustrating an example of a configuration of a document data processing device according to the present disclosure;

FIG. 17 is a flowchart illustrating an example of a flow of processing by the document data processing device according to the present disclosure;

FIG. 18 is a diagram illustrating combinations of interaction data to be subjected to similarity calculation according to the present disclosure;

FIG. 19 is a diagram illustrating a coupling pattern between increment interaction data and a group by a group coupling adjustment unit according to the present disclosure;

FIG. 20 is a diagram illustrating an example of a coupling relationship between an existing transitivity-based group and increment interaction data according to the present disclosure;

FIG. 21 is a diagram illustrating an example of a transitivity-based group subjected to adjustment by the group coupling adjustment unit according to the present disclosure;

FIG. 22 is a block diagram illustrating an example of a configuration of a document data processing device according to the present disclosure;

FIG. 23 is a flowchart illustrating an example of a flow of processing by the document data processing device at a time of generating co-occurrence word data according to the present disclosure;

FIG. 24 is a diagram illustrating procedure of generating the co-occurrence word data according to the present disclosure;

FIG. 25 is a diagram illustrating an example of the co-occurrence word data according to the present disclosure;

FIG. 26 is a flowchart illustrating an example of a flow of processing by the document data processing device at the time of displaying co-occurrence words according to the present disclosure;

FIG. 27 is a diagram illustrating an example of a search query input screen displayed by a search query acquisition unit according to the present disclosure;

FIG. 28 is a diagram illustrating a process of selecting the co-occurrence words displayed by a co-occurrence word recommendation unit according to the present disclosure;

FIG. 29 is a diagram illustrating an example of the search query input screen displayed by the search query acquisition unit according to the present disclosure;

FIG. 30 is a diagram illustrating a process of selecting the co-occurrence words displayed by the co-occurrence word recommendation unit according to the present disclosure;

FIG. 31 is a block diagram illustrating a hardware configuration of a document data processing device according to the present disclosure;

FIG. 32 is a block diagram illustrating an example of a configuration of the document data processing device according to the present disclosure; and

FIG. 33 is a flowchart illustrating an example of a flow of processing by the document data processing device according to the present disclosure.

### EXAMPLE EMBODIMENT

Hereinafter, each example embodiment will be described with reference to the drawings. In all the drawings, the same or corresponding components are denoted by the same reference signs, and the common description will be omitted.

### First Example Embodiment

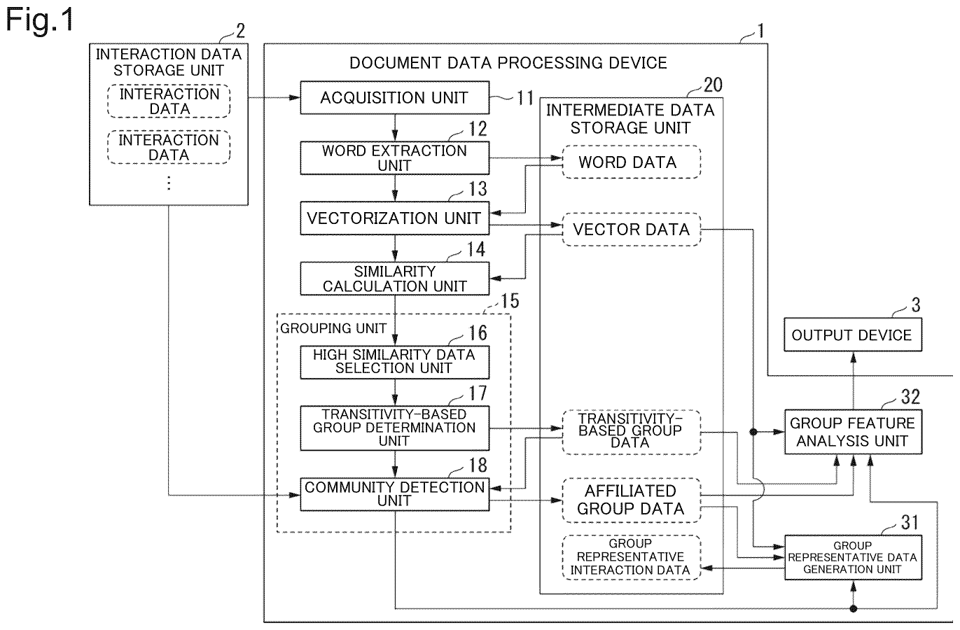

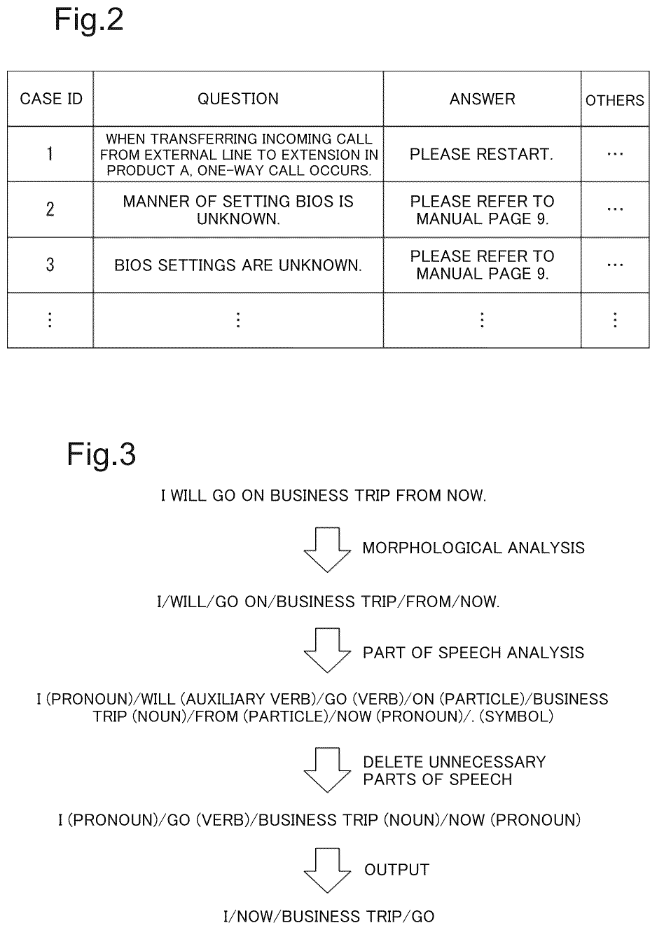

Hereinafter, one example embodiment according to the present disclosure will be described with reference to the drawings. As illustrated in FIG. 1, an interaction data storage unit 2 stores a plurality of pieces of interaction data. The interaction data storage unit 2 stores, for example, a table having items of “case identification (ID)”, “question”, “answer”, and “others” illustrated in FIG. 2, and a record in each row of the table is individual interaction data.

In the item of “case ID”, for example, a case ID that enables identification of each piece of interaction data with a different number is recorded as information that enables identification of each piece of interaction data. In the item “question”, for example, character string data of a question sentence indicating a content of a question received by an answerer from a questioner is recorded in a contact center or the like. In the item of “answer”, character string data of an answer sentence indicating a content of the answer by the answerer to the questioner is recorded. In the item of “others”, for example, information regarding a name of a product that the questioner asked is recorded.

A document data processing device 1 includes an acquisition unit 11, a word extraction unit 12, a vectorization unit 13, a similarity calculation unit 14, a grouping unit 15, an intermediate data storage unit 20, a group representative data generation unit 31, and a group feature analysis unit 32. The acquisition unit 11 is connected to the interaction data storage unit 2 via a wired or wireless line, for example, and acquires interaction data stored in the interaction data storage unit 2.

The word extraction unit 12 acquires character string data of a question sentence indicated in the item of “question” of the interaction data acquired by the acquisition unit 11 and character string data of an answer sentence indicated in the item of “answer”, and extracts words included in each piece of the acquired character string data by, for example, a method such as morphological analysis. Upon extracting the words from each piece of interaction data, the word extraction unit 12 generates word data having the following data format from the extracted words. The word extraction unit 12 generates, as the word data, word data including words (hereinafter, referred to as a word group of the question sentence) extracted from the character string data of the question sentence associated with the case ID and words (hereinafter, referred to as a word group of the answer sentence) extracted from the character string data of the answer sentence associated with the case ID for each interaction data in association with the case ID indicated in the item of “case ID” of the interaction data.

FIG. 3 is a diagram illustrating an example of a word extraction procedure performed by the word extraction unit 12. For example, in a case where the character string data is character string data of “I will go on a business trip from now.”, the word extraction unit 12 performs morphological analysis on the character string data and divides the character string data into words. The word extraction unit 12 analyzes a part of speech of each word divided by the morphological analysis. The word extraction unit 12 deletes words of a predetermined part of speech based on information on the part of speech of each word obtained as a result of a part-of-speech analysis, removes the information on the part of speech from the words remaining after the deletion, and outputs each word of “I”, “now”, “business trip”, and “go” as a word group. Although FIG. 3 illustrates an example in which the part of speech predetermined as the part of speech to be deleted is a part of speech other than “pronoun”, “noun”, and “verb”, any part of speech predetermined as the part of speech to be deleted can be determined. The word extraction unit 12 may output all the words obtained by the morphological analysis as a word group without performing the part-of-speech analysis.

The vectorization unit 13 vectorizes the character string data of each of the question sentence and the answer sentence for each interaction data based on each word group of the question sentence and the answer sentence for each of the word data generated by the word extraction unit 12. Hereinafter, a vector vectorized based on the word group of the question sentence is referred to as a question sentence vector, and a vector vectorized based on the word group of the answer sentence is referred to as an answer sentence vector. The vectorization unit 13 generates, for each word data, vector data in which a question sentence vector associated with a case ID and an answer sentence vector associated with the case ID are associated with the case ID included in the word data. As a method of vectorization performed by the vectorization unit 13, for example, a term frequency-inverse document frequency (TF-IDF) method is applied. Any other methods such as term frequency (TF) other than TF-IDF, best matching 25 (BM 25), Word2Vec, and Doc2Vec may be applied.

Based on the vector data generated by the vectorization unit 13, the similarity calculation unit 14 calculates the similarity between the pieces of interaction data for all combinations of two pieces of interaction data selected from the plurality of pieces of interaction data. Specifically, the similarity calculation unit 14 calculates, as the similarity between the pieces of interaction data, the similarity between the vectors in the same item associated with each of the two pieces of interaction data for each of combinations of the pieces of interaction data, that is, the similarity between the question sentence vectors and the similarity between the answer sentence vectors. As a similarity calculation method performed by the similarity calculation unit 14, for example, a cosine similarity method is applied. Any other method such as Euclidean norm other than the cosine similarity may be applied. The similarity calculation unit 14 generates, for each of combinations of two pieces of interaction data, similarity data including a combination of case IDs associated with a combination of two pieces of interaction data, similarity between question sentence vectors associated with the combination, and similarity between answer sentence vectors.

The grouping unit 15 includes a high similarity data selection unit 16, a transitivity-based group determination unit 17, and a community detection unit 18. The high similarity data selection unit 16 selects a combination of two pieces of interaction data having a high similarity relationship based on the similarity indicated by the similarity data generated for the combination of the two pieces of interaction data by the similarity calculation unit 14 and a predetermined similarity threshold.

The transitivity-based group determination unit 17 sets a combination of two pieces of interaction data having a high similarity relationship selected by the high similarity data selection unit 16 as two pieces of interaction data having a direct coupling relationship. The transitivity-based group determination unit 17 further indirectly selects interaction data having a coupling relationship, and determines each combination of the selected interaction data having a direct and indirect coupling relationship as a transitivity-based group. The transitivity-based group determination unit 17 generates, for the transitivity-based group identification information capable of identifying each of the transitivity-based groups, transitivity-based group data in which case IDs of pieces of interaction data belonging to each of the transitivity-based groups, information indicating a coupling relationship between pieces of interaction data, and similarity between question sentences and answer sentences associated with the coupling relationship are associated with each other.

The community detection unit 18 divides each of the transitivity-based groups by community detection for each of the transitivity-based groups based on the transitivity-based group data generated by the transitivity-based group determination unit 17. The community detection unit 18 determines each of the divided groups as an affiliated group of the interaction data. The community detection unit 18 is connected to the interaction data storage unit 2 via a wired or wireless line, for example, and acquires character string data indicated in each item of “question”, “answer”, and “other” of the interaction data associated with the case IDs of all the interaction data belonging to each of the affiliated groups from the interaction data storage unit 2. The community detection unit 18 generates affiliated group data in which a case ID of interaction data belonging to any affiliated group, character string data indicated in each item of “question”, “answer”, and “other” of the interaction data associated with the case ID, and affiliated group identification information indicating an affiliated group to which the interaction data associated with the case ID belongs are associated.

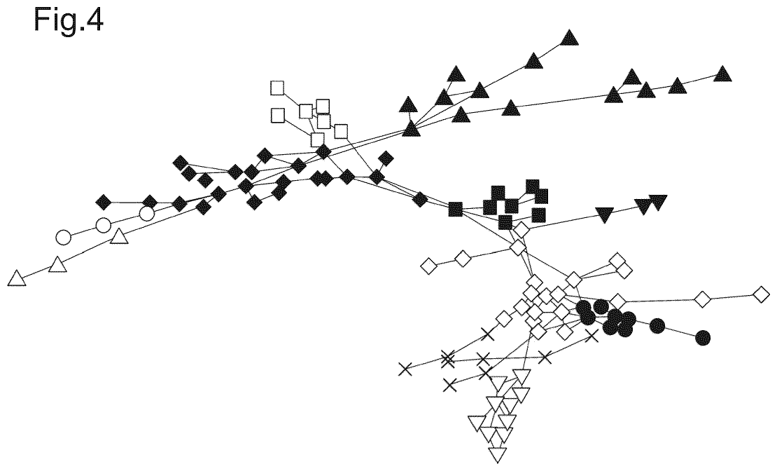

The community detection performed by the community detection unit 18 is a clustering method in graph network analysis, and for example, a greedy algorithm method is applied. Any other methods such as a method based on edge mediated centricity, which is a method other than a greedy algorithm method, and a method based on random walk may be applied. For example, it is assumed that a graph represented by a certain transitivity-based group determined by the transitivity-based group determination unit 17 has a shape illustrated in FIG. 4. In FIG. 4, each of 11 types of symbols including black and white circles, triangles, squares, diamonds, inverted triangles, and cross marks indicates individual pieces of interaction data belonging to the one transitivity-based group. As illustrated in FIG. 4, if a graph represented by one transitivity-based group becomes too large, one end and the other end of the graph may have different meanings. In this case, the community detection unit 18 divides the graph based on a shape of the graph of the transitivity-based group by the community detection, thereby dividing the interaction data into 11 groups represented by each of black and white circles, triangles, squares, diamonds, inverted triangles, and cross marks. Each of the divided 11 groups becomes an affiliated group.

The group representative data generation unit 31 generates group representative interaction data as a representative for each affiliated group from the interaction data belonging to each of the affiliated groups based on the affiliated group data generated by the community detection unit 18.

The group feature analysis unit 32 calculates a centroid vector of each of the affiliated groups based on vector data of the interaction data belonging to the affiliated group, based on the affiliated group data generated by the community detection unit 18. The group feature analysis unit 32 calculates a distance between the affiliated groups and a contribution degree of a word common between the affiliated groups based on the calculated centroid vector. The group feature analysis unit 32 performs analysis processing of drawing a structural diagram of the affiliated group or extracting a word common between the affiliated groups or a characteristic word of each of the affiliated groups based on the distance between the affiliated groups and the contribution degree of the word common between the affiliated groups.

The intermediate data storage unit 20 stores word data generated for each case ID by the word extraction unit 12, vector data generated for each case ID by the vectorization unit 13, transitivity-based group data generated by the transitivity-based group determination unit 17, affiliated group data generated by the community detection unit 18, group representative interaction data generated by the group representative data generation unit 31, and the like.

The output device 3 is, for example, a display device such as a liquid crystal display, and is connected to the group feature analysis unit 32. The output device 3 displays a result of the analysis processing and the like performed by the group feature analysis unit 32.

### Processing of Grouping Interaction Data by Document Data Processing Device 1

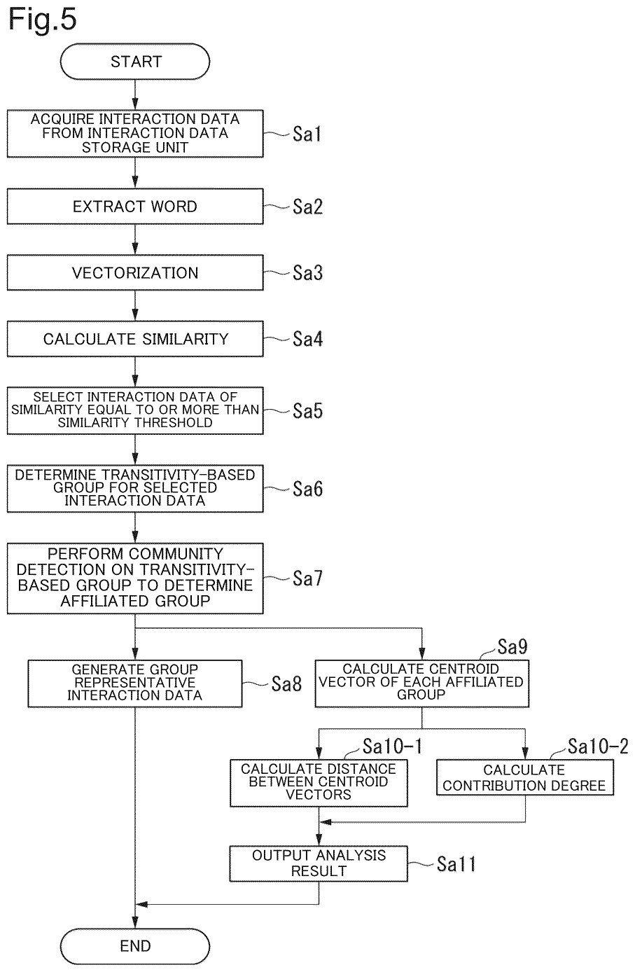

Hereinafter, processing in which the document data processing device 1 groups interaction data will be described with reference to a flowchart illustrated in FIG. 5. The acquisition unit 11 acquires the interaction data one by one from the interaction data storage unit 2 and outputs the acquired interaction data to the word extraction unit 12. Upon acquiring all the pieces of interaction data stored in the interaction data storage unit 2 and ending the output to the word extraction unit 12, the acquisition unit 11 outputs a completion notification signal to the word extraction unit 12 (Sa1).

Every time the word extraction unit 12 captures the interaction data output by the acquisition unit 11, the word extraction unit 12 extracts a word from each piece of the character string data of the item “question” and the character string data of the item “answer” of the captured interaction data according to the above-described procedure. In the following, an example will be described in which a part of speech predetermined as the part of speech to be deleted is a part of speech other than “noun” in the word extraction unit 12.

The word extraction unit 12 generates word data including a word extracted for each interaction data, and records the generated word data in the intermediate data storage unit 20. Upon receiving the completion notification signal from the acquisition unit 11 and completing generation and recording of the word data associated with all the captured interaction data before receiving the completion notification signal, the word extraction unit 12 outputs the completion notification signal to the vectorization unit 13 (Sa2).

Upon receiving the completion notification signal from the word extraction unit 12, the vectorization unit 13 vectorizes all the word data stored in the intermediate data storage unit 20. For example, it is assumed that the word extraction unit 12 extracts three words of “BIOS”, “setting”, and “manner” with respect to character string data “Manner of setting the BIOS is unknown.” indicated in the item of “question” of the interaction data with the case ID “2” illustrated in FIG. 2. In this case, the word data generated by the word extraction unit 12 includes “BIOS”, “setting”, and “manner” as the word group of the question sentence. Therefore, the vectorization unit 13 calculates the values of “0.65012”, “0.15678”, and “0.00110” for each of the words “BIOS”, “setting”, and “manner” by the TF-IDF method. A vector in which the values calculated by the vectorization unit 13 are listed as element values is a vector of the character string data of the question sentence with the case ID “2”. In a case of obtaining the question sentence vector associated with the word group of the question sentence included in one piece of word data and the answer sentence vector associated with the word group of the answer sentence, the vectorization unit 13 generates vector data by associating the question sentence vector and the answer sentence vector with the case ID included in the word data. The vectorization unit 13 records the generated vector data in the intermediate data storage unit 20.

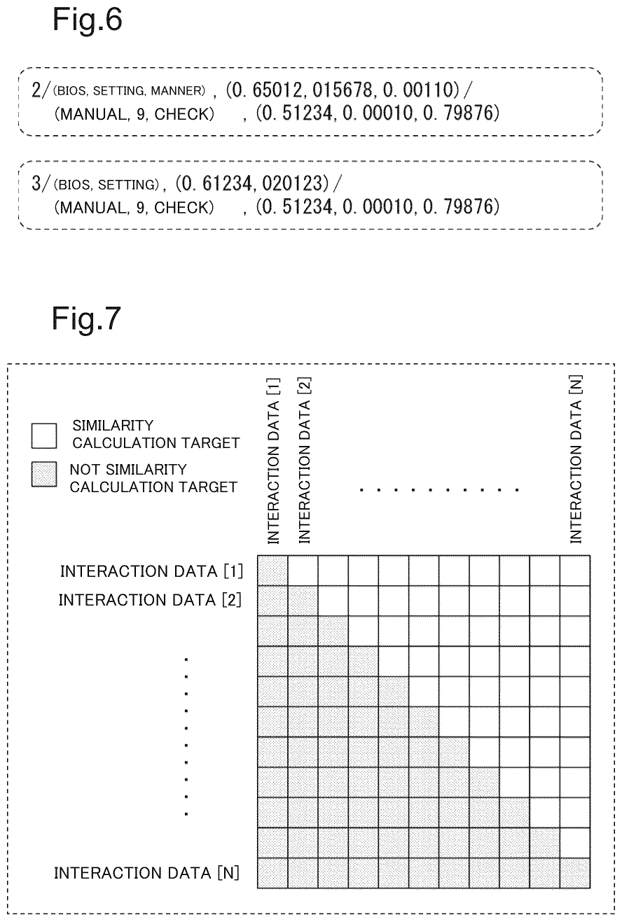

FIG. 6 is a diagram illustrating a part of the vector data stored in the intermediate data storage unit 20, and illustrates two pieces of vector data obtained from two pieces of interaction data with the case IDs “2” and “3” illustrated in FIG. 2. The case ID is indicated in a first section divided by “/”. Therefore, vector data surrounded by a dotted frame in an upper part of FIG. 6 is vector data associated with the case ID “2”, and vector data surrounded by a dotted frame in a lower part is vector data associated with the case ID “3”.

A question sentence vector is indicated in a second section divided by “/”, and an answer sentence vector is indicated in a third section. Character string data indicated in the item of the “question” of the interaction data with the case ID “3” illustrated in FIG. 2 is “BIOS settings are unknown.”, and a word group of the question sentence extracted by the word extraction unit 12 includes two words “BIOS” and “setting. Therefore, a word group (BIOS, setting) of the question sentence and (0.61234,0.20123) are illustrated as the question sentence vector in the second section. “0.61234” is an element value associated with the word “BIOS”, and “0.20123” is an element value associated with the word “setting”. Since the character string data indicated in the item of “answer” of the interaction data of the case IDs “2” and “3” is the same “Please refer to manual page 9.”, the answer sentence vectors of the case IDs “2” and “3” illustrated in FIG. 6 are the same.

Upon completion of the generation and recording of the vector data associated with all the word data stored in the intermediate data storage unit 20, the vectorization unit 13 outputs the completion notification signal to the similarity calculation unit 14 (Sa3).

Upon receiving the completion notification signal from the vectorization unit 13, the similarity calculation unit 14 selects a combination of two pieces of vector data from the vector data stored in the intermediate data storage unit 20, and calculates the similarity between the pieces of the vector data of the selected combination. In a case where there are N pieces (N is an integer of 2 or more) of interaction data stored in the interaction data storage unit 2, the total number of combinations is _{N}C₂, and the combinations are portions of white lattice regions in a relationship between two pieces of interaction data illustrated in FIG. 7. In the notation of “interaction data [n] (where n is an integer from 1 to N)” in FIG. 7, “n” is a number indicating a case ID.

The similarity calculation unit 14 sequentially reads a combination of two pieces of vector data associated with the portions of the white lattice regions in FIG. 7 from the intermediate data storage unit 20. The similarity calculation unit 14 calculates the similarity between the question sentence vectors of each combination of the read two pieces of vector data.

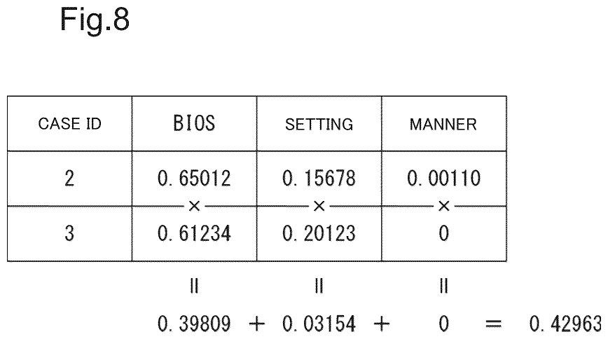

For example, a procedure in which the similarity calculation unit 14 calculates the cosine similarity between two question sentence vectors with the case IDs “2” and “3” illustrated in FIG. 6 will be described with reference to FIG. 8. As illustrated in FIG. 6, the question sentence vector with the case ID “2” is (BIOS, setting, manner) (0.65012,0.15678,0.00100), and the question sentence vector with the case ID “3” is (BIOS, setting) (0.61234,0.20123).

In a case where the words included in the two question sentence vectors are arranged in a column direction while the words common in the two question sentence vectors are represented in one column, and the two question sentence vectors are represented in a table form, a table illustrated in FIG. 8 is obtained. Here, the question sentence vector with the case ID “2” contains the word “manner”, but the question sentence vector with the case ID “3” does not contain the word “manner”. Therefore, the element value of “manner” of the question sentence vector with the case ID “3” is set to “0”.

The similarity calculation unit 14 multiplies two element values of a column element having a common word. In the example illustrated in FIG. 8, the word “BIOS” is multiplied by “0.65012×0.61234” to calculate “0.39809”. Similarly, the similarity calculation unit 14 calculates “0.03154” for the word “setting”, and calculates “0” for the word “manner”. The similarity calculation unit 14 calculates “0.42963”, which is the sum of the calculated three multiplication values, as the cosine similarity, that is, the similarity between the question sentence vectors.

The similarity calculation unit 14 calculates the similarity between the answer sentence vectors of the combination of two read pieces of vector data in a procedure similar to the procedure for calculating the similarity between the question sentence vectors. The similarity calculation unit 14 generates similarity data including a combination of two case IDs, similarity between the calculated question sentence vectors, and similarity between the calculated answer sentence vectors. For example, in the case of the example illustrated in FIG. 8, the similarity data generated by the similarity calculation unit 14 includes [2,3] indicating a combination of two case IDs, “0.4963” indicating the similarity between the calculated question sentence vectors, and the similarity between the calculated answer sentence vectors. The similarity calculation unit 14 outputs the generated similarity data to the high similarity data selection unit 16. The similarity calculation unit 14 generates similarity data for all combinations of the two pieces of vector data and outputs the similarity data to the high similarity data selection unit 16, and then outputs a completion notification signal to the high similarity data selection unit 16 (Sa4).

Upon capturing the similarity data output by the similarity calculation unit 14, the high similarity data selection unit 16 selects a combination of two pieces of interaction data having a high similarity relationship based on the similarity indicated by the captured similarity data and a predetermined similarity threshold.

The similarity data includes the similarity of the question sentence and the similarity of the answer sentence. Therefore, the high similarity data selection unit 16 selects a combination of two pieces of interaction data according to the following procedure, for example. For example, the high similarity data selection unit 16 selects a combination of two pieces of interaction data in which the similarity of the question sentence associated with the combination of the two pieces of interaction data is equal to or more than the similarity threshold and the similarity of the answer sentence associated with the combination of the two pieces of interaction data is equal to or more than the similarity threshold. Here, the similarity threshold associated with the question sentence and the similarity threshold associated with the answer sentence may be predetermined to be the same value, or may be predetermined to be different values, for example, the similarity threshold associated with the question sentence may be “0.4” and the similarity threshold associated with the answer sentence may be “0.3”.

Every time a combination of two pieces of interaction data is selected, the high similarity data selection unit 16 outputs similarity data associated with the combination to the transitivity-based group determination unit 17. In a case where the high similarity data selection unit 16 receives the completion notification signal from the similarity calculation unit 14, and further completes the processing of selecting based on the similarity threshold performed on each piece of similarity data captured before receiving the completion notification signal, the high similarity data selection unit 16 outputs the completion notification signal to the transitivity-based group determination unit 17 (Sa5).

The transitivity-based group determination unit 17 captures similarity data output from the high similarity data selection unit 16. Upon receiving the completion notification signal from the high similarity data selection unit 16, the transitivity-based group determination unit 17 selects interaction data having a direct and indirect coupling relationship based on a combination of two pieces of interaction data indicated by the pieces of similarity data captured before receiving the completion notification signal. The transitivity-based group determination unit 17 determines each combination of the selected interaction data as a transitivity-based group.

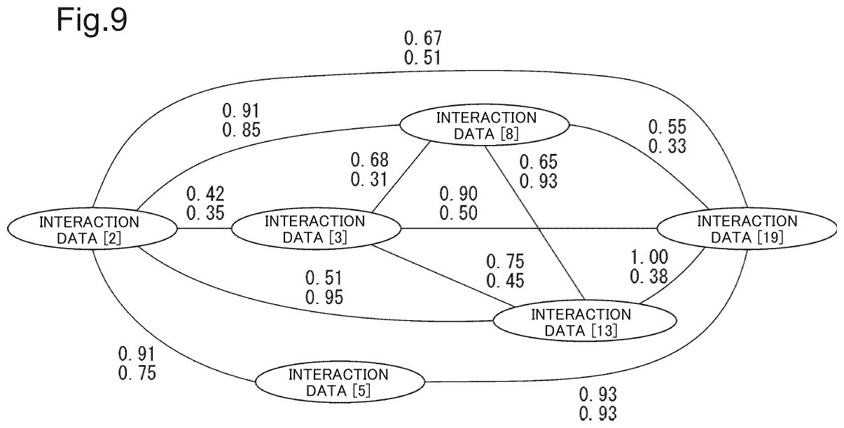

For example, it is assumed that 12 combinations of the case IDs included in each piece of similarity data captured by the transitivity-based group determination unit 17 are [2,3], [2,8], [2,5], [2,13], [2,19], [3,8], [3,13], [3,19], [5,19], [8,13], [8,19], and [13,19]. In this case, the transitivity-based group determination unit 17 determines the transitivity-based group illustrated in a graph of FIG. 9 based on the 12 combinations of the interaction data. In FIG. 9, each node indicates interaction data, and “m” in the notation of “interaction data [m]” indicated in each node is a number indicating a case ID. The two numerical values shown in an upper row and a lower row between the nodes are the similarity of the question sentence in the upper row and the similarity of the answer sentence in the lower row. In this example, the similarity calculation unit 14 sets “0.4” as the similarity threshold associated with the question sentence, and sets “0.3” as the similarity threshold associated with the answer sentence. Therefore, the similarity of the question sentences in the upper row among the nodes is “0.4” or more, and the similarity of the answer sentences in the lower row is “0.3” or more.

As illustrated in FIG. 9, the transitivity-based group determination unit 17 assumes a direct coupling relationship for each of the 12 combinations of the interaction data of the case IDs [2,3], [2,8], [2,5], [2,13], [2,19], [3,8], [3,13], [3,19], [5,19], [8,13], [8,19], and [13,19] included in the similarity data.

On the other hand, for example, there is no direct coupling relationship between the interaction data of the case ID “8” and the interaction data of the case ID “5”, but there is an indirect coupling relationship between the interaction data of the case ID “8” and the interaction data of the case ID “5” via the interaction data of the case IDs “2” and “19”. Therefore, the transitivity-based group determination unit 17 determines one transitivity-based group including not only interaction data having a direct coupling relationship but also interaction data having an indirect coupling relationship.

Upon determining one or more transitivity-based groups from the captured similarity data, the transitivity-based group determination unit 17 generates transitivity-based group identification information capable of identifying each of the transitivity-based groups. The transitivity-based group determination unit 17 generates, for each piece of the generated transitivity-based group identification information, transitivity-based group data in which case IDs of pieces of interaction data belonging to each transitivity-based group, information indicating a coupling relationship between pieces of interaction data, and degrees of similarity between question sentences and answer sentences associated with the coupling relationship are associated with each other. The transitivity-based group determination unit 17 records the generated transitivity-based group data in the intermediate data storage unit 20 and outputs a completion notification signal to the community detection unit 18 (Sa6).

Upon receiving the completion notification signal from the transitivity-based group determination unit 17, the community detection unit 18 performs the community detection described above for the transitivity-based group indicated by the transitivity-based group data stored in the intermediate data storage unit 20. The community detection unit 18 divides the transitivity-based group by the community detection, and determines each of the divided groups as an affiliated group of the interaction data. This affiliated group is a final group of the interaction data. The community detection unit 18 acquires character string data indicated in each item of “question”, “answer”, and “other” of the interaction data associated with the case IDs of all the interaction data belonging to each of the affiliated groups from the interaction data storage unit 2.

The community detection unit 18 generates affiliated group identification information capable of identifying each of the determined affiliated groups. For each piece of interaction data belonging to any affiliated group, the community detection unit 18 generates affiliated group data in which a case ID of each piece of interaction data, character string data indicated in each item of “question”, “answer”, and “other” of the interaction data associated with the case ID, and affiliated group identification information of an affiliated group to which the interaction data associated with the case ID belongs are associated with each other. The community detection unit 18 records the generated affiliated group data in the intermediate data storage unit 20.

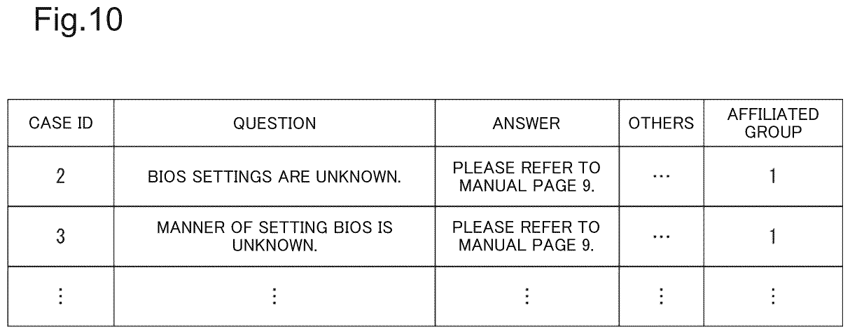

FIG. 10 is a diagram illustrating an example of affiliated group data stored in the intermediate data storage unit 20. A data format of the affiliated group data is a data format in which the item “affiliated group” is added to the data format of the interaction data illustrated in FIG. 2. In the item of “affiliated group”, affiliated group identification information is recorded. In the example illustrated in FIG. 10, a record associated with the interaction data with the case ID “1” illustrated in FIG. 2 is not illustrated. This means that the interaction data of the case ID “1” is not selected by the high similarity data selection unit 16 and is not included in the transitivity-based group and the affiliated group.

Upon recording the affiliated group data in the intermediate data storage unit 20, the community detection unit 18 outputs a completion notification signal to the group representative data generation unit 31 and the group feature analysis unit 32 (Sa7).

The group representative data generation unit 31 generates the group representative interaction data as a representative for each affiliated group as follows, for example. Upon receiving the completion notification signal from the community detection unit 18, the group representative data generation unit 31 refers to the affiliated group data stored in the intermediate data storage unit 20, and detects a case ID with which the affiliated group identification information matches for each affiliated group identification information. The case IDs matching the detected affiliated group identification information are hereinafter referred to as a same affiliated group case ID group. The group representative data generation unit 31 reads vector data associated with the case ID included in the same affiliated group case ID group from the intermediate data storage unit 20 for each same affiliated group case ID group. The group representative data generation unit 31 calculates a centroid vector of the same affiliated group case ID group for each of the same affiliated group case ID groups based on the vector data read associated with the same affiliated group case ID group. The calculated centroid vector is the centroid vector of the affiliated group associated with the same affiliated group case ID group.

The vector data includes a question sentence vector and an answer sentence vector. Therefore, the group representative data generation unit 31 sets a composite vector of the question sentence vector and the answer sentence vector included in one piece of vector data as the vector indicated by the vector data, and calculates the centroid vector based on the composite vector. Describing the composite vector of the question sentence vector and the answer sentence vector in more detail, for example, in a case where the question sentence vector has 100 dimensions and the answer sentence vector has 100 dimensions, it is assumed that the question sentence vector and the answer sentence vector have different dimensions even if they are the same word, and then a vector having components of the question sentence vector and the answer sentence vector, that is, a vector of 200 dimensions is set as the composite vector.

The group representative data generation unit 31 detects one vector having the closest distance to the centroid vector of the same affiliated group case ID group among the vectors indicated by the vector data of each case ID included in the same affiliated group case ID group. Since the detected vector is the closest to the centroid vector, it can be said that the interaction data associated with the vector is representative interaction data that best represents each feature of the interaction data of the case ID included in the same affiliated group case ID group.

The group representative data generation unit 31 detects the record associated with the case ID associated with the detected vector from the affiliated group data of the intermediate data storage unit 20, reads the content of each of the items of “question”, “answer”, “other”, and “affiliated group” of the detected record, and rearranges the read content in the order of “affiliated group”, “question”, “answer”, and “other” to generate the group representative interaction data. Upon generating the group representative interaction data for each same affiliated group case ID group, the group representative data generation unit 31 records the generated group representative interaction data in the intermediate data storage unit 20 (Sa8), and ends the processing.

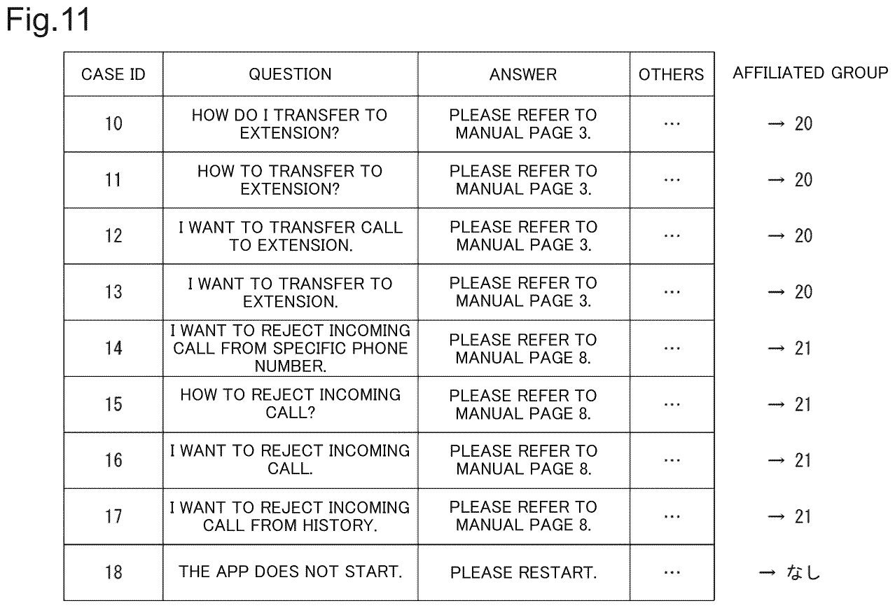

For example, it is assumed that the interaction data storage unit 2 stores the interaction data of the response case IDs “10” to “18” illustrated in FIG. 11. In this case, it is assumed that the affiliated group identification information of the affiliated group to which the interaction data with the case IDs “10” to “13” belong is “20”, the affiliated group identification information of the affiliated group to which the interaction data with the case IDs “14” to “17” belong is “21”, and the interaction data with the case ID “18” is not classified into any affiliated group.

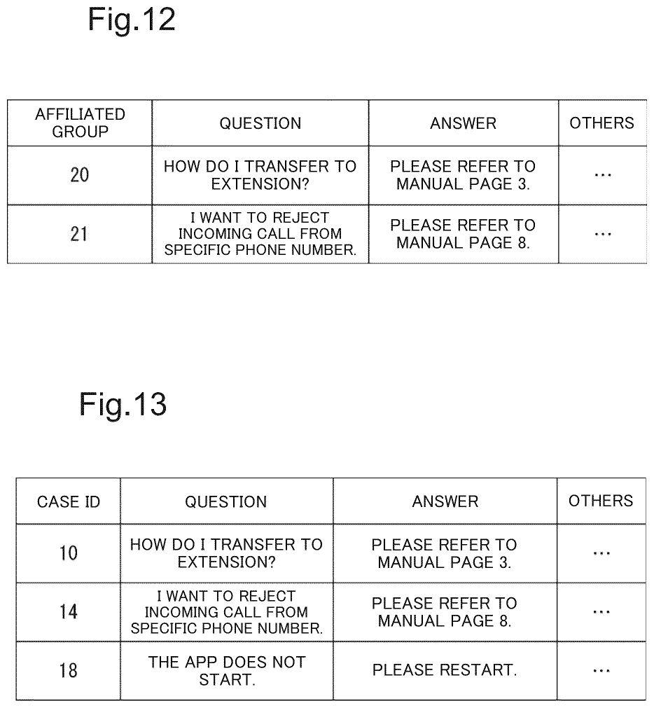

It is assumed that the group representative data generation unit 31 detects the interaction data of the case ID “10” as the group representative interaction data for the same affiliated group case ID group of the affiliated group identification information “20”. It is assumed that the group representative data generation unit 31 detects the interaction data of the case ID “14” as the group representative interaction data for the same affiliated group case ID group of the affiliated group identification information “21”. In this case, the group representative data generation unit 31 records the group representative interaction data illustrated in FIG. 12 in the intermediate data storage unit 20.

By using this group representative interaction data, for example, the following can be performed. In the interaction data stored in the interaction data storage unit 2, case IDs in which the contents of the items of “question”, “answer”, and “other” match the contents of the items of “question”, “answer”, and “other” in the record of the affiliated group identification information “20” of the group representative interaction data illustrated in FIG. 12 are detected. Here, the case ID “10” is detected. Therefore, in the interaction data storage unit 2, the interaction data with the case ID “10” is left, and the interaction data with the case IDs “11” to “13” classified as the affiliated group identification information “20” other than the case ID “10” is deleted.

Similarly, case IDs in which the contents of the items of “question”, “answer”, and “other” match the contents of the items of “question”, “answer”, and “other” in the record of the affiliated group identification information “21” of the group representative interaction data illustrated in FIG. 12 are detected. Here, the case ID “14” is detected. Therefore, in the interaction data storage unit 2, the interaction data with the case ID “14” is left, and the interaction data with the case IDs “15” to “17” classified as the affiliated group identification information “21” other than the case ID “14” is deleted.

As a result, it is possible to compress the nine records of the case IDs “10” to “18” of the interaction data of the interaction data storage unit 2 into three records of the case IDs “10”, “14”, and “18” as illustrated in FIG. 13 while maintaining the features of the interaction data belonging to the affiliated groups of the affiliated group identification information “20” and “21”.

Returning to FIG. 5, upon receiving the completion notification signal from the community detection unit 18, the group feature analysis unit 32 calculates the centroid vector of each of the same affiliated group case ID groups, that is, the centroid vector of each of the affiliated groups by the same procedure as the procedure described in the processing of Sa8 (Sa9). The group feature analysis unit 32 calculates a distance between the calculated centroid vectors of the affiliated groups (Sa10-1).

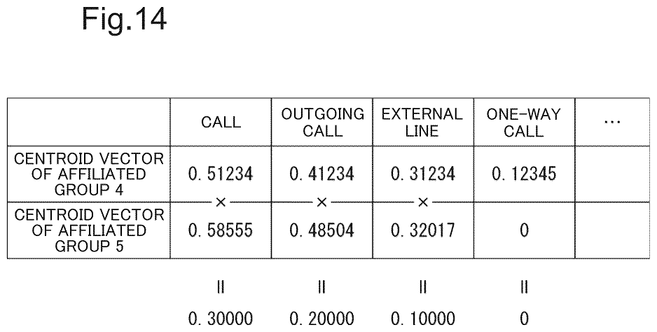

The group feature analysis unit 32 calculates a contribution degree of a word common between the affiliated groups based on the calculated centroid vectors of the affiliated groups. For example, it is assumed that the group feature analysis unit 32 calculates a record in the first row illustrated in FIG. 14 as the centroid vector of the affiliated group identification information “4” and calculates a record in the second row illustrated in FIG. 14 as the centroid vector of the affiliated group identification information “5”. Hereinafter, in the description of the affiliated group identification information “4”, the “identification information” is also abbreviated and described as an affiliated group “4”, and in the drawings, the “affiliated group 4” is also described. The same applies to numbers other than “4”.

The group feature analysis unit 32 multiplies element values of the common words in the centroid vector of the affiliated group 4 and the centroid vector of the affiliated group 5. In this case, for example, in a case where it exists in one centroid vector but does not exist in the other centroid vector as in the word “one-way call”, the element value of the centroid vector that does not exist is multiplied as “0”. The multiplication value obtained by this multiplication is the contribution degree of the word common between the affiliated group 4 and the affiliated group 5. That is, as illustrated in FIG. 14, the contribution degree of the word “call” becomes “0.30000”, the contribution degree of the word “outgoing call” becomes “0.20000”, the contribution degree of the word “external line” becomes “0.10000”, and the contribution degree of the word “one-way call” becomes “0” between the affiliated group 4 and the affiliated group 5.

The group feature analysis unit 32 generates contribution degree data in which each of the contributions calculated in a combination and a word associated with each of the contributions are associated with the combination of two pieces of affiliated group identification information indicating between the affiliated groups at the time of calculating the contribution degree (Sa10-2).

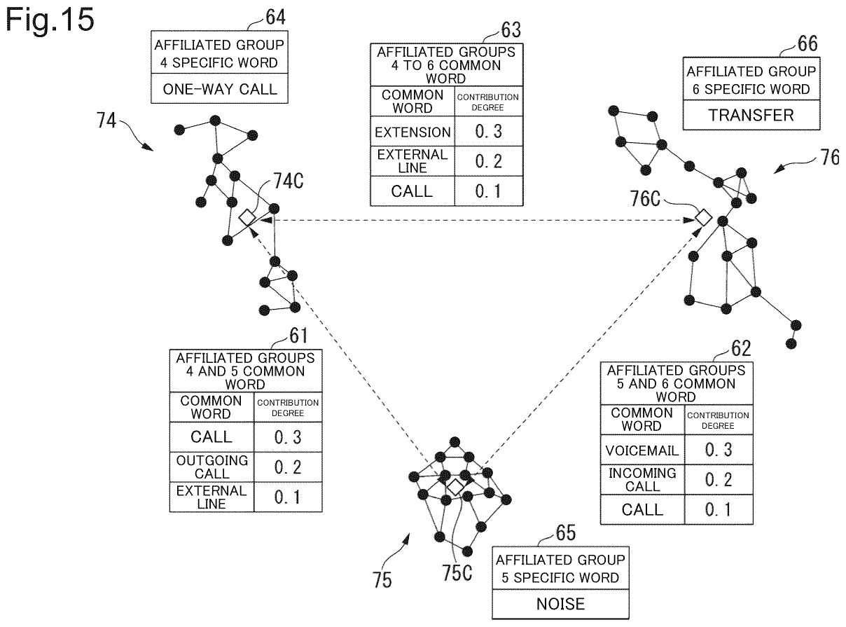

The group feature analysis unit 32 generates an image as illustrated in FIG. 15 based on the centroid vector calculated in the processing of Sa9, the distance between the centroid vectors calculated in the processing of Sa10-1, the contribution degree data generated in the processing of Sa10-2, the affiliated group data, and the transitivity-based group data. The group feature analysis unit 32 detects the same affiliated group case ID group from the affiliated group data. The group feature analysis unit 32 detects, for each detected same affiliated group case ID group, a coupling relationship of pieces of interaction data associated with case IDs included in the same affiliated group case ID group from the transitivity-based group data. The group feature analysis unit 32 generates a graph representing a coupling relationship between pieces of interaction data belonging to each of the affiliated groups based on the coupling relationship of the detected interaction data.

The group feature analysis unit 32 adds a symbol indicating the position of the centroid vector associated with each of the affiliated groups to the generated graph of each of the affiliated groups. The group feature analysis unit 32 adjusts the positions of the graphs of the affiliated groups in such a way that a distance between symbols indicating the positions of the centroid vectors becomes a distance between the centroid vectors calculated in the processing of Sa10-1. The group feature analysis unit 32 reduces dimensions in such a way that each graph of the affiliated group generated in this way can be displayed two-dimensionally. The group feature analysis unit 32 outputs a graph for each affiliated group dimensionally reduced to two-dimensions to the output device 3. As a result, for example, graphs (hereinafter, referred to as a graph 74, a graph 75, and a graph 76) indicated by reference numerals 74,75, and 76 associated with the affiliated groups 4, 5, and 6 illustrated in FIG. 15 are displayed on a screen of the output device 3.

FIG. 15 illustrates, as an example, information on the three affiliated groups 4, 5, and 6, but all the information of the affiliated groups included in the affiliated group data is displayed on the screen of the output device 3.

For example, in graphs 74, 75, and 76, a black circle indicates one piece of interaction data, and a connection line connecting between the black circles indicates that there is a coupling relationship between the pieces of interaction data. Diamond-shaped symbols denoted by symbols 74C, 75C, and 76C indicate the positions of the centroid vectors (hereinafter, a centroid vector 74C, a centroid vector 75C, and a centroid vector 76C will be referred to) of the affiliated groups 4, 5, and 6. A distance between the centroid vector 74C and the centroid vector 75C, a distance between the centroid vector 75C and the centroid vector 76C, and a distance between the centroid vector 76C and the centroid vector 74C are distances between the centroid vectors calculated in the processing of Sa10-1.

The group feature analysis unit 32 refers to the contribution degree data generated in the processing of Sa10-2, and detects a predetermined number of words, which are words having a contribution degree equal to or more than a predetermined contribution degree threshold and are predetermined in descending order of the contribution degree, for each of the affiliated groups as common words between the affiliated groups. Here, it is assumed that the contribution degree threshold is determined in advance to be, for example, “0.1”, and the predetermined number is determined in advance to be “3”. In this case, for example, in the case of the affiliated group 4 and the affiliated group 5 illustrated in FIG. 14, the contribution degree of each of “call”, “outgoing call”, and “external line” is 0.1 or more. Therefore, the group feature analysis unit 32 detects the words “call”, “outgoing call”, and “external line” as the common words between the affiliated group 4 and the affiliated group 5, arranges the detected words in descending order of the contribution degree, and generates a common word table indicating the contribution degree associated with each of the arranged words in association with each other. The group feature analysis unit 32 generates a common word table between the affiliated group 5 and the affiliated group 6, and between the affiliated group 6 and the affiliated group 4 by performing the same processing as that performed between the affiliated group 4 and the affiliated group 5.

The group feature analysis unit 32 detects a word existing only in any one of the affiliated groups as a unique word with reference to the contribution degree data generated in the processing of Sa10-2. In the case of the example illustrated in FIG. 14, between the affiliated group 4 and the affiliated group 5, the word “one-way call” exists only in the affiliated group 4, and thus, the contribution degree becomes “0”. Therefore, in a case where the word with the contribution degree of “0” is detected and the contribution degree of the detected word is “0” between any of the affiliated groups, the group feature analysis unit 32 sets the word as a unique word of the one affiliated group since there is one affiliated group including the word. Upon detecting the unique word for each affiliated group, the group feature analysis unit 32 generates a unique word table indicating the unique word of each affiliated group for each affiliated group.

The group feature analysis unit 32 displays each of generated common word tables between the affiliated groups and a unique word table for each affiliated group on the screen of the output device 3, for example, as indicated by reference numerals 61, 62, 63, 64, 65, and 66 in FIG. 15 (Sa11), and ends the processing. Reference numerals 61, 62, and 63 are common word tables between the affiliated groups, and reference numerals 64, 65, and 66 are unique word tables for each affiliated group.

### Effects of Document Data Processing Device 1

In the document data processing device 1, the similarity calculation unit 14 calculates similarity between vectors of character string data of the same item included in the interaction data. The grouping unit 15 selects interaction data having a direct and indirect coupling relationship based on the similarity and the similarity threshold, and sets each combination having the selected coupling relationship as a transitivity-based group of the interaction data. In this case, the interaction data to be processed by the document data processing device 1 is not the document data classified in the category in advance. The document data processing device 1 vectorizes each piece of character string data based on a word included in each piece of character string data included in the interaction data, and classifies the interaction data into groups using similarity between the vectors as an index. Therefore, by using the document data processing device 1, it is possible to determine similarity between document data even if the document data is not classified into categories in advance, and it is possible to efficiently extract document data having similarity as a group based on the determination result.

A machine learning method called clustering is generally known as a method of collecting similar data, but in this method, it is necessary to determine in advance how many classes to classify. If an appropriate number of classes cannot be determined, dissimilar data may be classified into the same class, or similar data may be classified into different classes. Data indicating a rare event may be considered to be similar to another event or may be buried. In a case where the amount of data is small, it is possible to predict the number of classes in advance, but in a case of a large amount of unorganized data, it is difficult to know how many classes exist in advance. On the other hand, in the document data processing device 1, it is not necessary to determine the number of classes in advance, and it is possible to appropriately group a large amount of unorganized interaction data based on the similarity.

The grouping unit 15 further divides and re-groups the transitivity-based group by community detection for each of the transitivity-based groups, and determines an affiliated group of the interaction data. Therefore, since a group of more accurate and highly precise interaction data can be specified, for example, even an inexperienced answerer can determine how to efficiently answer a question by referring to the interaction data belonging to the affiliated group associated with the question. By referring to the affiliated group data indicating the accurate and highly precise affiliated group in this manner, it is possible to know the number of pieces of interaction data belonging to each of the affiliated groups, and thus, it is possible to easily extract frequently appearing questions from a large amount of interaction data. Therefore, for example, a creation time can be greatly reduced as compared with a case where frequently asked questions (FAQ) of the interaction data are manually created.

In a first-reception contact center or the like, it is necessary to quickly respond to a large number of questions, and there are many questions regarding the same event. In the first-reception contact center or the like, since the contact center plays a role of first reception, tracking is not performed until the content of the question is resolved, and an appropriate answer to the question is not necessarily indicated in the past interaction data. Therefore, in the contact center or the like, simply searching accumulated past interaction data often results in interaction data of a plurality of similar events being obtained as a search result, and it takes much time to further find desired interaction data indicating an appropriate answer from the interaction data.

In such a case, it is also conceivable to construct a system that makes it easy to find desired interaction data by causing a large amount of interaction data to be trained as training data using artificial intelligence (AI) and machine learning. However, in the artificial intelligence (AI) and the machine learning, the quality of learning data is directly linked to a correct answer rate. Therefore, it is necessary to improve the quality by cleansing the interaction data. In this case, the group representative data generation unit 31 in the document data processing device 1 is configured to generate group representative interaction data as a representative for each affiliated group from the interaction data belonging to each affiliated group of the interaction data grouped by the grouping unit 15. By using this group representative interaction data, as described with reference to FIGS. 11 to 13, since the interaction data can be compressed, that is, cleansed, the quality of the interaction data can be improved, and high-quality interaction data can be used as learning data of AI and machine learning.

The group feature analysis unit 32 included in the document data processing device 1 calculates a centroid vector of each affiliated group, and calculates a distance between the affiliated groups and a contribution degree of a word common between the affiliated groups based on the calculated centroid vector. As a result, for example, the analysis result as described with reference to FIG. 15 can be output to the output device 3 to visualize the features of the affiliated group, and for example, it is possible to grasp why such grouping has been performed.

### Second Example Embodiment

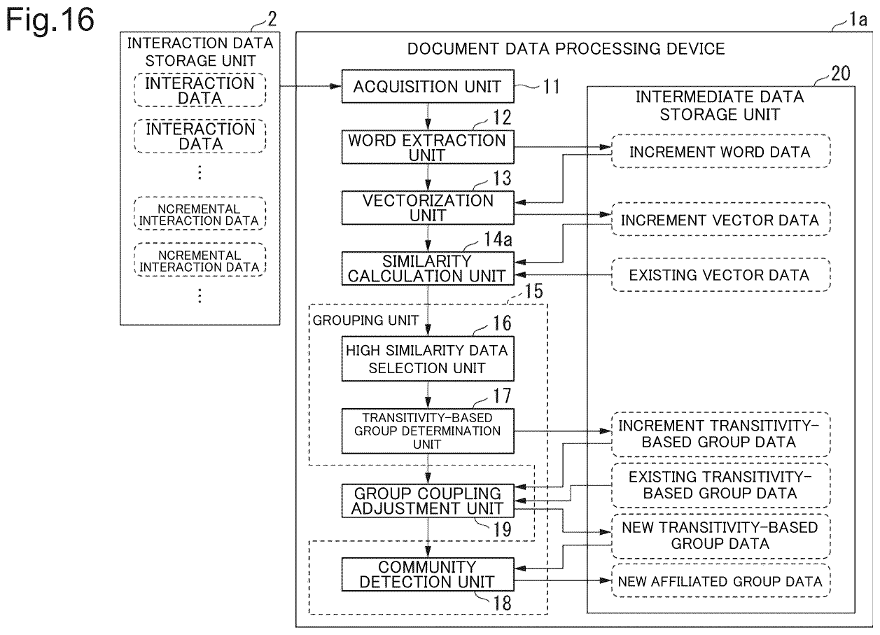

Hereinafter, one example embodiment according to the present disclosure will be described with reference to the drawings. A contact center and the like operate every day, and in a case where a period of time elapses after the document data processing device 1 illustrated in FIG. 1 groups the interaction data, new interaction data is accumulated in a interaction data storage unit 2. In order to reflect a content of the accumulated new interaction data, it is necessary to update transitivity-based group data and affiliated group data. A document data processing device 1a illustrated in FIG. 16 is a device used in such an update scene.

As illustrated in FIG. 16, the document data processing device 1a has a configuration in which the similarity calculation unit 14 in the document data processing device 1 illustrated in FIG. 1 is replaced with a similarity calculation unit 14a, and a group coupling adjustment unit 19 is further included. An acquisition unit 11, a word extraction unit 12, a vectorization unit 13, a high similarity data selection unit 16, and a transitivity-based group determination unit 17 are denoted by the same reference numerals in each of the document data processing device 1 and the document data processing device 1a, but there is a difference between the interaction data and the increment interaction data that is the interaction data to be added in each processing target, and thus there is a difference in configuration associated with the difference between the processing targets. Although not illustrated in FIG. 16, the document data processing device 1a includes a group representative data generation unit 31 and a group feature analysis unit 32 included in the document data processing device 1.

The similarity calculation unit 14a has a configuration included in the similarity calculation unit 14, and further has the following configuration. Based on the increment vector data generated by the vectorization unit 13 from the increment interaction data, the similarity calculation unit 14a calculates similarity between the increment interaction data for all the combinations of two pieces of increment interaction data selected from the plurality of pieces of increment interaction data. Based on existing vector data and increment vector data, the similarity calculation unit 14a calculates similarity between the existing interaction data and the increment interaction data for all combinations of the existing interaction data and the increment interaction data selected from the existing interaction data and the increment interaction data. The existing vector data is vector data generated by the vectorization unit 13 in the processing of Sa3 of FIG. 5 from existing interaction data (hereinafter, referred to as existing interaction data) that is interaction data before the increment interaction data is added.

The group coupling adjustment unit 19 detects, for each of the increment interaction data belonging to the increment transitivity-based group, the number of couplings between the increment interaction data and the existing transitivity-based group formed by the existing interaction data and the number of couplings in the increment transitivity-based group indicated by the number of other increment interaction data to which the increment interaction data is coupled. The existing transitivity-based group is a transitivity-based group determined by the transitivity-based group determination unit 17 in the processing of Sa6 in FIG. 5. The increment transitivity-based group is a transitivity-based group determined by the transitivity-based group determination unit 17 based on the similarity calculated by the similarity calculation unit 14a according to the addition of the increment interaction data and the similarity threshold value. The group coupling adjustment unit 19 selects a destination to which each piece of the increment interaction data belongs based on the number of couplings to be detected, the similarity calculated by the similarity calculation unit 14a according to the addition of the increment interaction data, and the transitivity-based group formed from the existing interaction data according to the selection, and re-groups the transitivity-based group formed from the existing interaction data according to the selection and the increment transitivity-based group.

### Re-Grouping Processing in a Case Where Document Data Processing Device 1a Adds Interaction Data

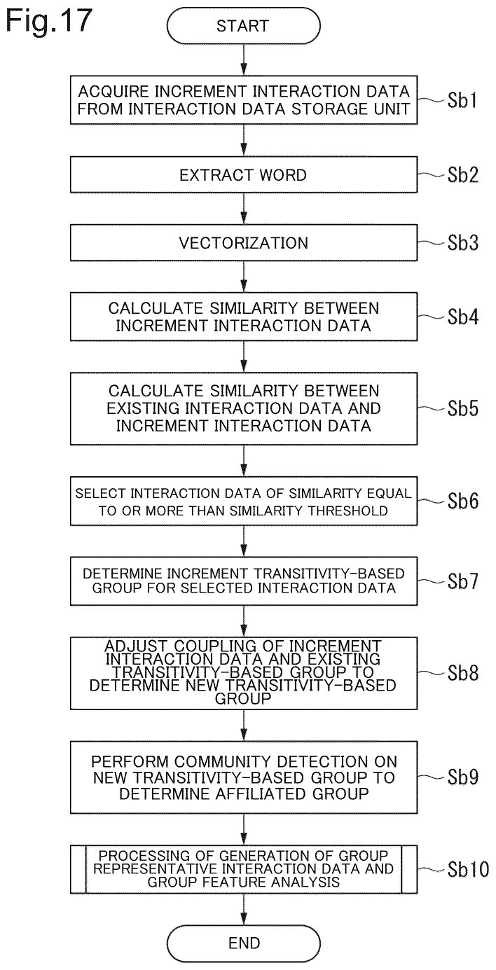

Hereinafter, with reference to a flowchart illustrated in FIG. 17, the processing of re-grouping performed by the document data processing device 1a at a time of adding the interaction data will be described. Before the flowchart illustrated in FIG. 17 is started, it is assumed that a state of an intermediate data storage unit 20 is a state in which at least the existing vector data generated in the processing of Sa3 of FIG. 5 and the transitivity-based group data (hereinafter, referred to as existing transitivity-based group data) generated in the processing of Sa6 are stored.

In a case where the interaction data is additionally recorded in the interaction data storage unit 2, the acquisition unit 11 acquires the added interaction data one by one as increment interaction data, and outputs the acquired increment interaction data to the word extraction unit 12. Upon acquiring all the increment interaction data stored in the interaction data storage unit 2 and ending the output to the word extraction unit 12, the acquisition unit 11 outputs an increment completion notification signal to the word extraction unit 12 (Sb1).

Every time the increment interaction data output from the acquisition unit 11 is captured, the word extraction unit 12 performs the same processing as the processing of extracting a word in the processing of Sa2 of FIG. 5 on the captured increment interaction data to generate word data. The word extraction unit 12 records the generated word data in an intermediate data storage unit 20 as increment word data. For example, the increment interaction data output by the acquisition unit 11 includes discrimination information that can be discriminated as the added interaction data, and in a case where word data for the interaction data including the discrimination information is generated, the word extraction unit 12 records the generated word data in the intermediate data storage unit 20 as increment word data that can be discriminated from existing word data. The word extraction unit 12 receives the increment completion notification signal from the acquisition unit 11, and further outputs the increment completion notification signal to the vectorization unit 13 upon completion of generation and recording of the increment word data associated with all the captured increment interaction data before the increment completion notification signal is received (Sb2).

Upon receiving the increment completion notification signal from the word extraction unit 12, the vectorization unit 13 performs the same processing as the vectorization processing in the processing of Sa3 in FIG. 5 on all the increment word data stored in the intermediate data storage unit 20 to generate vector data. The vectorization unit 13 records the generated vector data in the intermediate data storage unit 20 as increment vector data distinguishable from existing vector data. Upon completion of the generation and recording of the increment vector data associated with all the increment word data stored in the intermediate data storage unit 20, the vectorization unit 13 outputs an increment completion notification signal to the similarity calculation unit 14a (Sb3).

In receiving the increment completion notification signal from the vectorization unit 13 by the similarity calculation unit 14a, the increment vector data and the existing vector data are already stored in the intermediate data storage unit 20. It is also possible to adopt a procedure in which the similarity calculation unit 14a calculates the similarity between all pieces of interaction data obtained by adding the increment interaction data to the existing interaction data and redetermines the transitivity-based group based on the calculated similarity. However, as the number of all pieces of interaction data including the increment interaction data increases, the calculation amount of the similarity also increases.

In order to suppress the increase in the calculation amount, the similarity calculation unit 14a calculates the similarity by narrowing down the similarity to the similarity necessary for redefining the transitivity-based group accompanying the addition of the increment interaction data. Specifically, the similarity between the N pieces of existing interaction data is excluded from the calculation target of the similarity calculation unit 14a. The similarity between the N pieces of existing interaction data is the similarity calculated in the processing of Sa4 of FIG. 5, and the existing transitivity-based group data is generated based on the similarity and is already stored in the intermediate data storage unit 20. Therefore, even if the similarity between the N pieces of existing interaction data is excluded from the calculation target of the similarity calculation unit 14a, the similarity between the N pieces of existing interaction data necessary for re-grouping can be obtained from the existing transitivity-based group data.

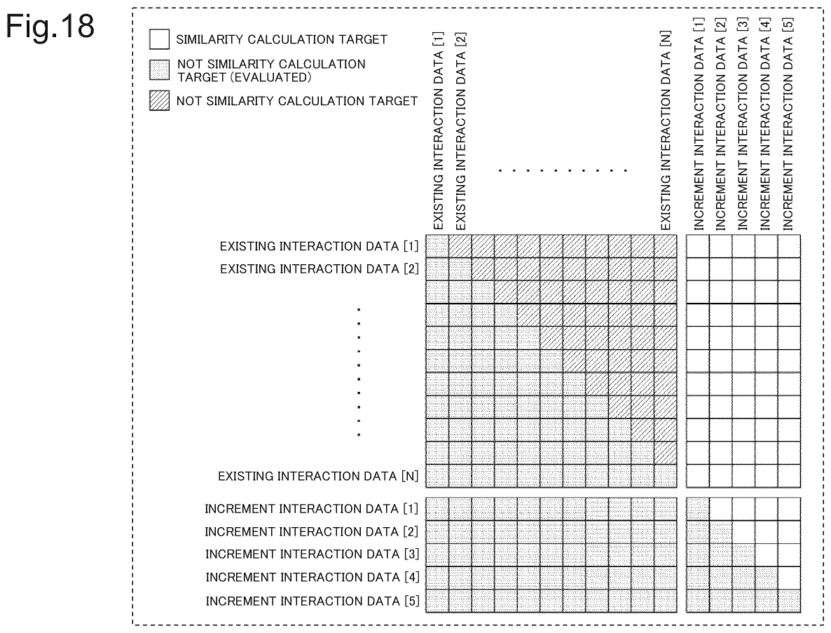

For example, in a case where five pieces of increment interaction data are added in a state where there are N pieces of existing interaction data, the number of combinations of all pieces of interaction data including the increment interaction data in the existing interaction data increases from _{N}C₂ to _{(N+5)}C₂. The number of increased combinations becomes _{(N+5)}C₂-_{N}C₂=5N+10. Among the “5N+10” combinations, the “5N” portions are associated with the combinations of the existing interaction data and the increment interaction data indicated by an upper right white lattice region in a relationship between the interaction data illustrated in FIG. 18. The “10” portions are associated with a portion of a combination of increment interaction data indicated by the white lattice region at a lower right.

Upon receiving the increment completion notification signal from the vectorization unit 13, the similarity calculation unit 14a outputs the increment start notification signal to the high similarity data selection unit 16. The similarity calculation unit 14a selects, from the increment vector data stored in the intermediate data storage unit 20, a combination of two pieces of increment vector data associated with the portion of the combination of the pieces of increment interaction data indicated by the white lattice region at the lower right of FIG. 18. The similarity calculation unit 14a calculates the similarity between the two pieces of increment interaction data by the same processing as the processing of calculating the similarity in the processing of Sa4 for the selected two pieces of increment vector data. That is, the similarity calculation unit 14a calculates the similarity between the question sentence vectors included in each of the two selected increment vector data and the similarity between the answer sentence vectors. The similarity calculation unit 14a generates similarity data including the case ID of each of the two selected increment vector data, the similarity between the question sentence vectors, and the similarity between the answer sentence vectors, and outputs the generated similarity data to the high similarity data selection unit 16. The similarity calculation unit 14a generates similarity data for all combinations of the two pieces of increment vector data and outputs the similarity data to the high similarity data selection unit 16 (Sb4).

Upon completion of the processing of Sb4, the similarity calculation unit 14a selects, from the existing vector data and the increment vector data stored in the intermediate data storage unit 20, a combination of the existing vector data and the increment vector data associated with the portion of the combination of the existing interaction data and the increment interaction data indicated by the white lattice region in the upper right of FIG. 18. The similarity calculation unit 14a calculates the similarity between the existing interaction data and the increment interaction data for the selected combination of the existing vector data and the increment vector data by the same processing as the processing of calculating the similarity in the processing of Sa4. That is, the similarity calculation unit 14a calculates the similarity between the question sentence vectors included in each of the existing vector data and the increment vector data and the similarity between the answer sentence vectors.

The similarity calculation unit 14a generates similarity data including the case IDs of the selected existing vector data and the selected increment vector data, the similarity between the question sentence vectors, and the similarity between the answer sentence vectors, and outputs the generated similarity data to the high similarity data selection unit 16. The similarity calculation unit 14a generates similarity data for all combinations of the existing vector data and the increment vector data and outputs the similarity data to the high similarity data selection unit 16, and then outputs an increment completion notification signal to the high similarity data selection unit 16 (Sb5). The order of the processing of Sb4 and the processing of Sb5 may be switched, and in the case of switching, the processing performed at the end of the processing of Sb5 by the similarity calculation unit 14a to output the increment completion notification signal to the high similarity data selection unit 16 is performed at the end of the processing of Sb4.

Upon receiving the increment start notification signal from the similarity calculation unit 14a, the high similarity data selection unit 16 outputs the increment start notification signal to the transitivity-based group determination unit 17. The high similarity data selection unit 16 captures similarity data output from the similarity calculation unit 14a. The high similarity data selection unit 16 performs the same processing as the processing of selecting the similarity data based on the similarity threshold in the processing of Sa5 of FIG. 5 on each piece of similarity data captured from the reception of the increment start notification signal to the reception of the increment completion notification signal from the similarity calculation unit 14a. The high similarity data selection unit 16 outputs the selected similarity data to the transitivity-based group determination unit 17. In a case where the processing of selecting the similarity data based on the similarity threshold is completed for each of the similarity data captured from the reception of an increment start notification signal to the reception of an increment completion notification signal, the high similarity data selection unit 16 outputs the increment completion notification signal to the transitivity-based group determination unit 17 (Sb6).

After receiving the increment start notification signal from the high similarity data selection unit 16, the transitivity-based group determination unit 17 captures similarity data output from the high similarity data selection unit 16. The transitivity-based group determination unit 17 performs the same processing as the processing of generating the transitivity-based group data in the processing of Sa6 of FIG. 5 on the similarity data captured from the reception of the increment start notification signal to the reception of the increment completion notification signal from the high similarity data selection unit 16 to generate the transitivity-based group data. The transitivity-based group determination unit 17 records the generated transitivity-based group data in the intermediate data storage unit 20 as increment transitivity-based group data, and outputs a completion notification signal to the group coupling adjustment unit 19 (Sb7).

Upon receiving the completion notification signal from the transitivity-based group determination unit 17, the group coupling adjustment unit 19 adjusts the coupling relationship between the increment interaction data and the existing interaction data based on the existing transitivity-based group data and the increment transitivity-based group data stored in the intermediate data storage unit 20.

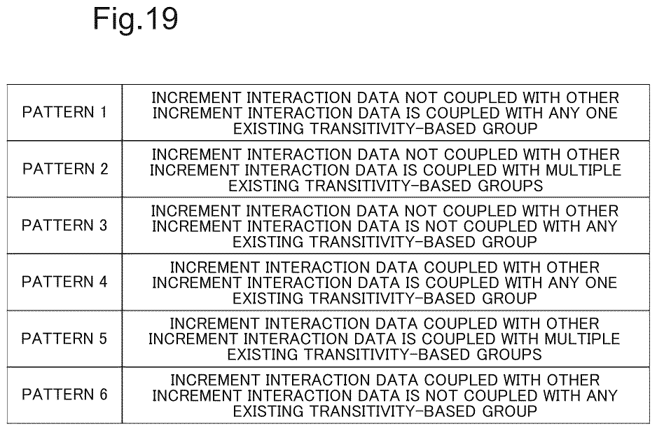

As a coupling relationship between the increment interaction data and the existing transitivity-based group, a coupling relationship of six patterns illustrated in FIG. 19 is assumed. The group coupling adjustment unit 19 determines whether the coupling relationship between the increment interaction data and the existing transitivity-based group corresponds to any coupling relationship of six patterns, and performs individual coupling adjustment for each determined pattern.

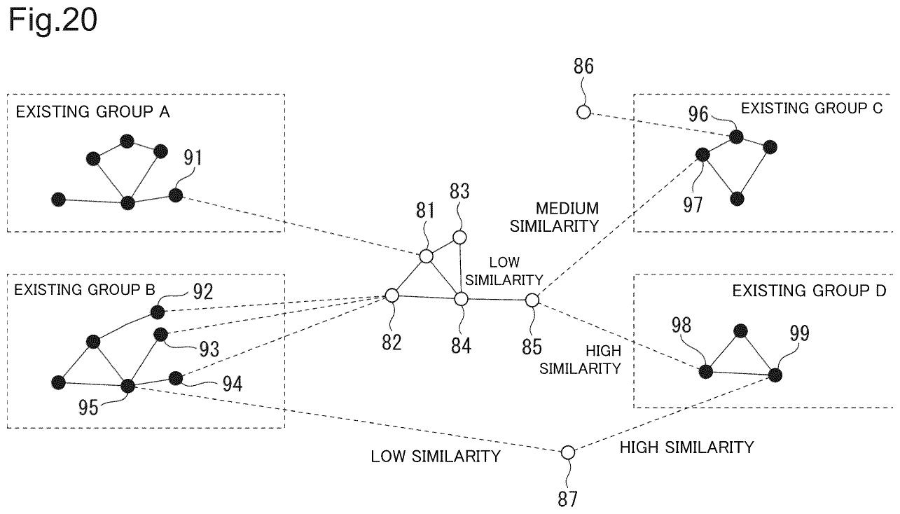

FIG. 20 is a diagram illustrating an example of a coupling relationship between the increment interaction data and the existing transitivity-based group. In FIG. 20, black circles indicate existing interaction data, white circles indicate increment interaction data, and solid lines or broken lines indicate that there is a coupling relationship. The existing groups A, B, C, and D are existing transitivity-based groups, and are specified from the existing transitivity-based group data.

The increment transitivity-based group specified from the increment transitivity-based group data is formed between increment interaction data having a coupling relationship or between the increment interaction data and the existing interaction data. Therefore, in the example illustrated in FIG. 20, one increment transitivity-based group is formed by the increment interaction data of reference numerals 81 to 85 and the existing interaction data of reference numerals 91 to 94, 97, and 98, one increment transitivity-based group is formed by the increment interaction data of reference numeral 86 and the existing interaction data of reference numeral 96, and one increment transitivity-based group is formed by the increment interaction data of reference numeral 87 and the existing interaction data of reference numerals 95 and 99. Hereinafter, the increment interaction data of reference numeral 81 will be described as increment interaction data 81, and the increment interaction data of reference numeral 82 to 87 and the existing interaction data of reference numeral 91 to 99 will be similarly described.

The group coupling adjustment unit 19 detects, for each of the increment interaction data belonging to the increment transitivity-based group, the number of couplings between the increment interaction data and the existing transitivity-based group and the number of couplings in the increment transitivity-based group indicated by the number of other increment interaction data to which the increment interaction data is combined. For example, in the case of the increment interaction data 82, since the increment interaction data 82 is combined with the existing interaction data 92, 93, and 94 belonging to the existing group B, the group coupling adjustment unit 19 detects “3” as the number of couplings between the increment interaction data 82 and the existing group B. Since the increment interaction data 82 is combined with the other increment interaction data 81 and 84, the group coupling adjustment unit 19 detects “2” as the number of couplings in the increment transitivity-based group of the increment interaction data 82.

The increment interaction data 86 is associated with the case of (Pattern 1). The increment interaction data 86 is only coupled with the existing interaction data 96 belonging to the existing group C. Therefore, the group coupling adjustment unit 19 sets the existing group C to which the increment interaction data 86 belongs.

(Pattern 2), (Pattern 4), and (Pattern 5) can be considered as a case where one piece of increment interaction data belongs to a plurality of groups when the existing transitivity-based group and the increment transitivity-based group are regarded as the same group. In this case, an affiliation destination of the one piece of increment interaction data is set as a group having a large number of couplings, and the coupling with a group other than the group is released. In a case where the number of couplings with the plurality of groups is the same, the group having the larger similarity is set as an affiliation destination of the one piece of increment interaction data, and coupling with groups other than the group is released.

The increment interaction data 87 is associated with (Pattern 2). The increment interaction data 87 is coupled with the existing interaction data 95 belonging to the existing group B and the existing interaction data 99 belonging to the existing group D. That is, the increment interaction data 87 has one coupling for each of the existing group B and the existing group D. In this case, the group coupling adjustment unit 19 refers to the increment transitivity-based group data, refers to the similarity between the increment interaction data 87 and the existing interaction data 95, and refers to the similarity between the increment interaction data 87 and the existing interaction data 99, and assigns the one with the larger similarity as an affiliation destination of the increment interaction data 87.

The similarity includes the similarity of the question sentence and the similarity of the answer sentence, and thus, for example, the one with higher similarity in both the question and answer sentences is set as an affiliation destination. In a case where the similarity of either one is large, but the similarity of the other is the same or small, the one having a larger total value of both the similarities may be set as the affiliation destination, or the one having a larger average value of both the similarities may be set as the affiliation destination.

Here, since the similarity between the increment interaction data 87 and the existing interaction data 99 is larger than the similarity between the increment interaction data 87 and the existing interaction data 95, the group coupling adjustment unit 19 sets the affiliation destination of the increment interaction data 87 as the affiliated group D.

In a case where the number of couplings and the similarity are the same, for example, the affiliation destination may be determined as in the following (a), (b), (c), and (d). For example, it is assumed that case IDs of all pieces of interaction data including the increment interaction data are recorded in such a way as to have larger numbers in order of being recorded in the interaction data storage unit 2. That is, the interaction data having a smaller value of the case ID number is regarded as more past interaction data. In this case, the affiliation destination may be determined as in the following (a) and (b).
(a) The interaction data having a smaller value of the number of the case ID of the interaction data as the candidate of the affiliation destination may be set as the affiliation destination.
(b) In a case where a phenomenon that the same problem is likely to occur at a certain time is observed, the value of the number of the case ID of the increment interaction data for which it is necessary to determine the affiliation destination is compared with the value of the number of the case ID of the interaction data that is the candidate for the affiliation destination, and the interaction data that is the candidate for the affiliation destination of which the value of the number is closer, that is, the absolute value of the difference between the values of the numbers of the case IDs is smaller is set as the affiliation destination.

It is assumed that the registration date and time is assigned to all the pieces of interaction data including the increment interaction data and recorded in the interaction data storage unit 2. In this case, instead of the method of (a), the interaction data registered earlier in the registration date and time, that is, registered in the past, may be set as the affiliation destination. Instead of the method of (b), the interaction data that is a candidate of the affiliation destination to which the registration date and time close to the registration date and time allocated to the increment interaction data for which it is necessary to determine the affiliation destination is allocated may be set as the affiliation destination.
(c) In the above example, the word extraction unit 12 excludes words of a part of speech other than nouns when generating the word data and the increment word data. On the other hand, the word extraction unit 12 generates, for each piece of character string data, morpheme analysis result data including words of all parts of speech extracted from the character string data by the morphological analysis in the order of extraction, separately from the word data and the increment word data, and records the morpheme analysis result data in the intermediate data storage unit 20. In this case, a word included in the morphological analysis result data of the increment interaction data for which it is necessary to determine the affiliation destination is compared with a word included in each of the morphological analysis result data of the interaction data as a candidate of the affiliation destination, and the interaction data as a candidate of the affiliation destination having a larger number of matched words is set as the affiliation destination.
(d) The identity of the order of the words, in other words, the context may be considered. For example, it is assumed that the words are arranged in the order of (word A, word B, word C) in the increment word data of the increment interaction data for which it is necessary to determine the affiliation destination, the words are arranged in the order of (word A, word C, word B) in the word data of the interaction data as a candidate of one affiliation destination, and the words are arranged in the order of (word C, word A, word B) in the word data of the interaction data as a candidate of the other affiliation destination. In this case, the order sameness of the words is compared depending on how many times the adjacent words are swapped to match the order of (word A, word B, word C) of the increment interaction data for which it is necessary to determine the affiliation destination. If the order of the word C and the word B is exchanged, the order of (word A, word C, word B) becomes (word A, word B, word C). On the other hand, as for the other (word C, word A, word B), the order of the word C and the word A is changed to (word A, word C, word B), and furthermore, the order of the word C and the word B is changed to (word A, word B, word C). That is, while the one can be matched in the order of arrangement of the words of the increment interaction data for which the affiliation destination needs to be determined by one swap, the other needs to be swapped twice. Therefore, in this case, the interaction data as the candidate of one affiliation destination having the sequence of (word A, word C, word B) with the small number of times of swaps has higher identity and is closer to the context of the increment interaction data for which it is necessary to determine the affiliation destination, and thus, the interaction data as the candidate of the one affiliation destination is set as the affiliation destination. Instead of using the increment word data of the increment interaction data and the word data of the interaction data as described above, the morphological analysis result data described in (c) may be stored in the intermediate data storage unit 20, and the comparison of the identity may be performed based on the word included in the morphological analysis result data.

The methods of (a), (b), (c), and (d) described above may be combined to determine the affiliation destination.

The increment interaction data 81 and 82 are associated with (Pattern 4). The increment interaction data 81 is coupled with the existing interaction data 91 belonging to the existing group A and the increment interaction data 82, 83, and 84. The number of couplings between the increment interaction data 81 and the existing group A is “1”. On the other hand, the number of couplings in the increment transitivity-based group of the increment interaction data 81 is “3”. Therefore, the group coupling adjustment unit 19 sets the affiliation destination of the increment interaction data 81 as the increment transitivity-based group to which the increment interaction data 81 belongs.

The increment interaction data 82 is coupled with the existing interaction data 92, 93, and 94 belonging to the existing group B and the increment interaction data 81 and 84. The number of couplings between the increment interaction data 82 and the existing group B is “3”. In contrast, the number of couplings in the increment transitivity-based group of the increment interaction data 82 is “2”. Therefore, the group coupling adjustment unit 19 sets the existing group B as an affiliation destination of the increment interaction data 82.

The increment interaction data 85 is associated with (Pattern 5). The increment interaction data 85 is coupled with the existing interaction data 97 belonging to the existing group C, the existing interaction data 98 belonging to the existing group D, and the increment interaction data 84. The number of couplings between the increment interaction data 85 and the existing group C is “1”. The number of couplings between the increment interaction data 85 and the existing group D is “1”. The number of couplings in the increment transitivity-based group of the increment interaction data 84 is “1”. Therefore, since the number of couplings is equal to “1”, the group coupling adjustment unit 19 determines the affiliation destination of the increment interaction data 85 according to the similarity of each coupling. Here, since the similarity between the increment interaction data 85 and the existing interaction data 98 is the largest, the group coupling adjustment unit 19 sets the affiliation destination of the increment interaction data 85 as the affiliated group D.

The increment interaction data 83 and 84 are associated with (Pattern 6). Since the increment interaction data 83 and 84 are not combined with the existing interaction data, the group coupling adjustment unit 19 sets the group to which the increment interaction data 83 and 84 belong as the increment transitivity-based group to which the increment interaction data 83 and 84 belong.

The increment interaction data associated with (Pattern 3) is the increment interaction data that is not coupled with any piece of increment interaction data and is not coupled with any piece of existing interaction data.

In other words, the similarity is less than the similarity threshold. Since such increment interaction data is not selected by the high similarity data selection unit 16, the increment interaction data is not to be adjusted by the group coupling adjustment unit 19.

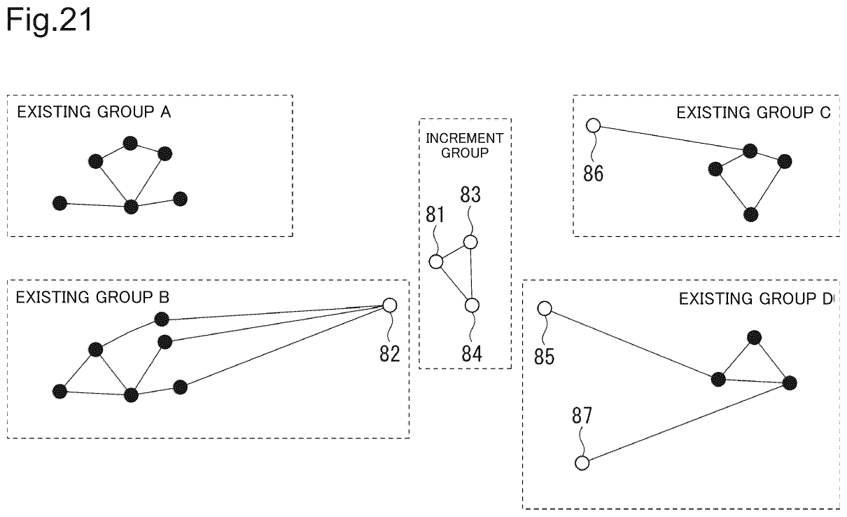

Therefore, in a case where the coupling adjustment by the group coupling adjustment unit 19 is performed with respect to the example illustrated in FIG. 20, the increment interaction data 81 to 87 have a coupling relationship as illustrated in FIG. 21. Each of the existing groups A, B, C, and D and the increment group illustrated in FIG. 21 becomes a new transitivity-based group. The group coupling adjustment unit 19 generates new transitivity-based group data for the new transitivity-based group, records the generated new transitivity-based group data in the intermediate data storage unit 20, and outputs the completion notification signal to the community detection unit 18 (Sb8).

Upon receiving the completion notification signal whose output source is the group coupling adjustment unit 19, the community detection unit 18 reads new transitivity-based group data stored in the intermediate data storage unit 20, and performs the same processing as the processing of Sa7 of FIG. 5 on the read new transitivity-based group data (Sb9). As a result, the intermediate data storage unit 20 stores new affiliated group data associated with the new transitivity-based group data. Thereafter, with respect to the new affiliated group data stored in the intermediate data storage unit 20, generation of the group representative interaction data and processing of Sa8, Sa9, Sa10-1, Sa10-2, and Sa11 in FIG. 5 as processing of the group feature analysis are performed by the group representative data generation unit 31 and the group feature analysis unit 32 (Sb10), and the processing ends.

### Effects of Document Data Processing Device 1a

Although the existing interaction data and the increment interaction data can be grouped together by the document data processing device 1, if such grouping is performed, the relevance with the transitivity-based group and the affiliated group formed by the existing interaction data cannot be understood, or it takes a long time to perform the processing for grouping. On the other hand, by using the document data processing device 1a illustrated in FIG. 16, the similarity calculation unit 14a calculates the similarity of the question sentence and the similarity of the answer sentence between the increment interaction data based on the vectors associated with the increment interaction data, and calculates the similarity of the question sentence and the similarity of the answer sentence between the increment interaction data and the existing interaction data based on the vectors associated with the increment interaction data and the vectors associated with the existing interaction data.

The transitivity-based group determination unit 17 narrows down the existing interaction data having a high similarity relationship with the increment interaction data, and determines an increment transitivity-based group indicating a coupling relationship between the increment interaction data and a coupling relationship between the increment interaction data and the existing interaction data. The group coupling adjustment unit 19 determines an affiliation destination of the increment interaction data based on the number of couplings between the increment interaction data and the existing transitivity-based group, the number of couplings in the increment transitivity-based group indicated by the number of other increment interaction data to which the increment interaction data is combined, and the similarity, and re-groups the existing transitivity-based group and the increment transitivity-based group. In this way, since a new transitivity-based group is formed by regrouping while using the existing transitivity-based group, it is possible to grasp the relevance between the two groups. As described with reference to FIG. 18, since the similarity between the pieces of existing interaction data is excluded from the similarity calculation target in similarity calculation unit 14a, the calculation amount can be reduced, and the time required for the processing for grouping can be reduced.

### Other Configuration Examples Common to Document Data Processing Devices 1 and 1a

Hereinafter, another configuration example common to the document data processing device 1 illustrated in FIG. 1 and the document data processing device 1a illustrated in FIG. 16 will be described.

In performing vectorization, the vectorization unit 13 may perform vectorization by weighting a predetermined specific word. For example, in the grouping performed by the transitivity-based group determination unit 17 or the community detection unit 18, the vectorization unit 13 may perform weighting such as weighting a small value for a word that is not important and weighting a large value for a word that is important. The analysis result illustrated in FIG. 15 may be used as a determination index of the importance of each word in the grouping performed by the transitivity-based group determination unit 17 or the community detection unit 18. For example, for the first time, the processing illustrated in FIG. 5 is performed in a state where the vectorization unit 13 is not caused to perform the weighting of the word, and the analysis result illustrated in FIG. 15 is displayed on the screen of the output device 3. The word shown in the common word tables 61 to 63 displayed on the screen of the output device 3 is set as an important word, the word shown in the unique word tables 64 to 65 is selected as an unimportant word, and a weighting value for the selected word is determined. Then, in a case where the processing of FIG. 5 is performed again or the increment interaction data is added to the interaction data storage unit 2, the processing of FIG. 17 may be performed to regroup and confirm the affiliated group. After the processing of FIG. 17 is performed, the screen of the output device 3 may be referred to again, the important word and the unimportant word may be selected again, a weighting value for the selected word may be determined, and the processing of FIG. 5 may be performed again. This makes it possible to specify a more accurate and highly precise group.

In the document data processing devices 1 and 1a, the group representative data generation unit 31 calculates a centroid vector for each affiliated group and generates group representative interaction data. On the other hand, the group representative data generation unit 31 may select one piece of interaction data representing the affiliated group by an index other than the centroid vector and generate the group representative interaction data. For example, the group representative data generation unit 31 may cause a large language model (LLM) to summarize the contents of all the pieces of interaction data belonging to the affiliated group and generate the group representative interaction data. The group representative data generation unit 31 may set the content obtained by connecting all the contents of the item “question” of all the pieces of interaction data belonging to the affiliated group as the content of the item “question” of the group representative interaction data, set the content obtained by connecting all the contents of the item “answer” of all the pieces of interaction data as the content of the item “answer” of the group representative interaction data, and set the content obtained by connecting all the contents of the items “others” of all the pieces of interaction data as the content of the item “others” of the group representative interaction data to generate the group representative interaction data.

As described with reference to FIG. 5, in a case where the group representative data generation unit 31 calculates the centroid vector in the processing of Sa8, the group feature analysis unit 32 may perform the processing of Sa10-1 and Sa10-2 by diverting the centroid vector calculated by the group representative data generation unit 31 without performing the processing of Sa9.

In the document data processing devices 1 and 1a, the group feature analysis unit 32 detects a common word common between the affiliated groups and a specific word specific to the affiliated group based on the contribution degree. On the other hand, based on the contribution degree, the group feature analysis unit 32 may analyze and output various kinds of statistical information regarding the affiliated group, such as detecting various words representing features of each of the affiliated groups, such as a word having a large difference between the affiliated groups or a word common to all the affiliated groups. The group feature analysis unit 32 may classify words existing in the affiliated group by using an inverse document frequency (IDF) vector. For example, in calculating the centroid vector of the affiliated group, the group feature analysis unit 32 calculates the IDF vector of each word of the affiliated group. The group feature analysis unit 32 may classify a word having a large calculated IDF value as a word existing in a smaller number of affiliated groups, classify a word having a small IDF value as a word existing in a larger number of affiliated groups, and output a classified result to the output device 3 as an analysis result.

In the document data processing devices 1 and 1a, the group feature analysis unit 32 performs the analysis processing related to the affiliated group, that is, the processing of Sa9, Sa10-1, Sa10-2, and Sa11 of FIG. 5 based on the affiliated group data, but similar analysis processing may be performed on the transitivity-based group.

In the document data processing devices 1 and 1a, the community detection unit 18 generates affiliated group data in the data format illustrated in FIG. 10, but may generate affiliated group data having items of “case ID” and “affiliated group” excluding items of “question”, “answer”, and “others” in the data format illustrated in FIG. 10. Even in the affiliated group data of such a data format, it is possible to specify which affiliated group identification information the interaction data associated with the case ID corresponds to. However, in this case, since the affiliated group data does not include the items of “question”, “answer”, and “others”, the group representative data generation unit 31 acquires the interaction data associated with the case ID indicated in the item of “case ID” from the interaction data storage unit 2 and generates the group representative interaction data when generating the group representative interaction data with reference to the affiliated group data.

In the document data processing devices 1 and 1a, the community detection unit 18 may generate affiliated group data including information indicating a coupling relationship between pieces of interaction data associated with each case ID included in the affiliated group data. In this case, the group feature analysis unit 32 can generate the graphs 74, 75, and 76 of the interaction data belonging to each of the affiliated groups illustrated in FIG. 15 by using a coupling relationship between the interaction data included in the affiliated group data without referring to the transitivity-based group data.

The document data processing devices 1 and 1a may be configured not to include the community detection unit 18. In this case, the transitivity-based group is the final group of the interaction data.

The group representative data generation unit 31 and the group feature analysis unit 32 perform the processing performed on the affiliated group data on the transitivity-based group data. The document data processing devices 1 and 1a include the community detection unit 18, but may be configured in such a way that the user can select whether to cause the community detection unit 18 to perform processing.

In the document data processing devices 1 and 1a, the high similarity data selection unit 16 selects, as a combination of two pieces of interaction data having a high similarity relationship, a combination of two pieces of interaction data in which the similarity of the question sentence associated with the combination of the two pieces of interaction data is equal to or more than the similarity threshold and the similarity of the answer sentence associated with the combination of the two pieces of interaction data is equal to or more than the similarity threshold. On the other hand, the high similarity data selection unit 16 may select, as a combination of two pieces of interaction data having a high similarity relationship, a combination of two pieces of interaction data in which a total value of the similarity of the similarity data of the question sentence and the similarity associated with the answer sentence in the combination of the two pieces of interaction data is equal to or more than a predetermined similarity threshold.

In the document data processing devices 1 and 1a, the high similarity data selection unit 16 makes a determination as to whether the similarity is equal to or more than the similarity threshold, and selects the interaction data having the similarity equal to or more than the similarity threshold or the increment interaction data as the interaction data having the high similarity. On the other hand, depending on how the similarity threshold is determined, the high similarity data selection unit 16 may determine whether the similarity threshold is exceeded, and select the interaction data having the similarity exceeding the similarity threshold or the increment interaction data as the interaction data having the high similarity.

Similarly, the group feature analysis unit 32 makes a determination indicating whether the contribution degree is equal to or more than the contribution degree threshold, and selects a word having a contribution degree equal to or more than the contribution degree threshold. On the other hand, depending on the way of setting the contribution degree threshold value, the group feature analysis unit 32 may make a determination indicating whether the contribution degree threshold value is exceeded, and select a word having a contribution degree exceeding the contribution degree threshold value.

The document data processing devices 1 and 1a are configured to perform processing on both character string data of a question sentence indicated in the item “question” included in the interaction data and character string data of an answer sentence indicated in the item “answer”. On the other hand, the document data processing devices 1 and 1a may perform processing for any one of the character string data of the question sentence and the character string data of the answer sentence.

### Third Example Embodiment

Hereinafter, one example embodiment according to the present disclosure will be described with reference to the drawings. In a contact center or the like, interaction data is searched in a case where an answerer who is responding to the questioner wants to answer the questioner with reference to past interaction data. In this case, in a case where the answerer cannot think of an appropriate search word for obtaining desired interaction data, the search accuracy decreases, and an appropriate answer cannot be given to the questioner. On the other hand, even if the search word conceived by the answerer does not have an information amount sufficient to obtain the desired interaction data, it is desirable to improve the probability that the desired interaction data can be obtained without deteriorating the search accuracy, and to make it possible to give a more appropriate answer to the questioner.

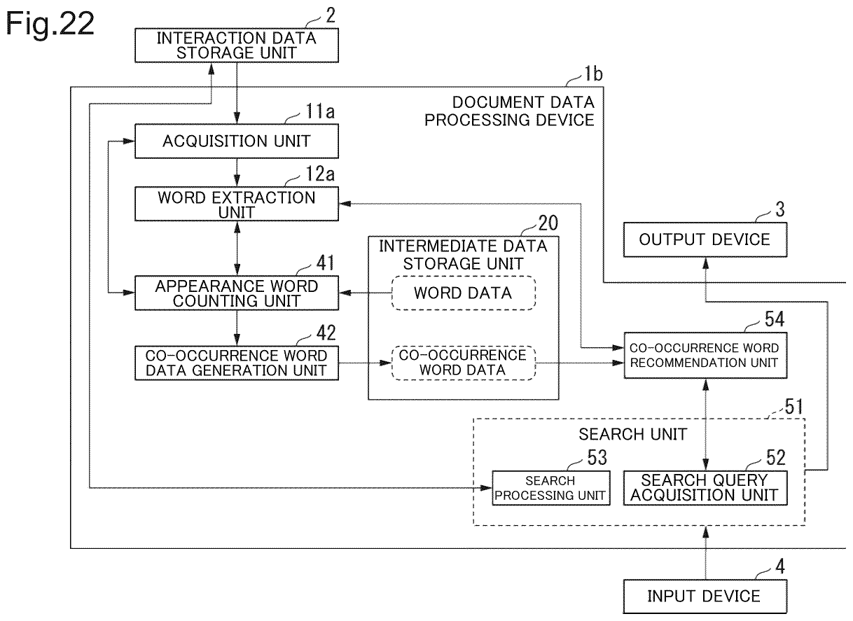

A document data processing device 1b illustrated in FIG. 22 is the document data processing device 1 illustrated in FIG. 1, in which the acquisition unit 11 is replaced with an acquisition unit 11a, the word extraction unit 12 is replaced with a word extraction unit 12a, and the document data processing device 1b further includes an appearance word counting unit 41, a co-occurrence word data generation unit 42, a search unit 51, and a co-occurrence word recommendation unit 54. Although not illustrated in FIG. 22, the document data processing device 1b may include a vectorization unit 13, similarity calculation units 14 and 14a, a grouping unit 15, a group coupling adjustment unit 19, a group representative data generation unit 31, and a group feature analysis unit 32 included in the document data processing devices 1 and 1b.

In a case where the acquisition unit 11a is connected to the interaction data storage unit 2 and receives a interaction data acquisition request signal from another functional unit, the acquisition unit 11a reads the interaction data one by one from the interaction data storage unit 2 and outputs the read interaction data to the requesting functional unit. After the acquisition unit 11a acquires all the interaction data stored in the interaction data storage unit 2 and ends the output to the functional unit of the request source, the acquisition unit 11a outputs the completion notification signal to the functional unit of the request source. The acquisition unit 11a may include the configuration of the acquisition unit 11.

Upon receiving the word extraction request signal including the character string data from another functional unit, the word extraction unit 12a extracts a word from the character string data included in the received word extraction request signal in the same procedure as the word extraction procedure performed by the word extraction unit 12, and outputs a word extraction completion signal including a word group listing the extracted word to the functional unit of the request source. The word extraction unit 12a may include the configuration of the word extraction unit 12.

The appearance word counting unit 41 selects each of the words included in the word group including one or more words as the reference word. Here, the word group is a word group of a predetermined item included in the word data stored in the intermediate data storage unit 20 or a word group included in the word extraction completion signal output by the word extraction unit 12a. For each word group of the selection source of the reference word, the appearance word counting unit 41 sets a word existing within a predetermined number of words before and after the reference word as a co-occurrence word of the reference word, and counts the number of appearances of the co-occurrence words within the predetermined number of words before and after the reference word.

The co-occurrence word data generation unit 42 calculates a total value of the number of appearances counted for each word group by the appearance word counting unit 41 for the combination of the reference word and the co-occurrence words associated with the reference word. The co-occurrence word data generation unit 42 generates co-occurrence word data in which each of the calculated total values is associated with a combination of the reference word and co-occurrence words associated with each of the total values.

The search unit 51 is connected to the output device 3 and the input device 4, and includes a search processing unit 53 and a search query acquisition unit 52. Here, the input device 4 is, for example, a keyboard, a mouse, a touch panel, or the like. Upon receiving the search request signal from the input device 4, the search processing unit 53 detects, from the interaction data storage unit 2 based on the search condition included in the received search request signal and the search query, the interaction data including the character string data indicated by the search query in a format in accordance with the search condition, in the character string data indicated in the predetermined item of the interaction data. The search processing unit 53 outputs the detected interaction data to the output device 3.

Here, the search condition is, for example, one of a condition for performing an AND search and a condition for performing an OR search. In a case where a plurality of pieces of character string data separated by a space is included in the search query and in a case of the condition for performing the AND search, the search processing unit 53 detects the interaction data in which all pieces of character string data of the plurality of pieces of character string data indicated by the search query are included in any portion of the character string data of the predetermined item. On the other hand, in a case where a plurality of pieces of character string data is included in the search query and in a case of a condition for performing the OR search, the search processing unit 53 detects the interaction data in which at least one of the plurality of pieces of character string data indicated by the search query is included in any portion of the character string data of the predetermined item.

The search query acquisition unit 52 displays a search query input screen for writing the search query on the output device 3. After the character string is written in the search query input frame on the displayed search query input screen, the search query acquisition unit 52 captures the written character string into character string data, and outputs the character string data as a search query to the co-occurrence word recommendation unit 54.

The co-occurrence word recommendation unit 54 detects co-occurrence word data having each of the words indicated by the search query output by the search query acquisition unit 52 as a reference word from the co-occurrence word data generated by the co-occurrence word data generation unit 42. In a case where the common co-occurrence words are included in the detected co-occurrence word data, the co-occurrence word recommendation unit 54 sets a total value of the number of appearances of the common co-occurrence words as the number of appearances of the common co-occurrence words. The co-occurrence word recommendation unit 54 arranges each of the co-occurrence words included in the detected co-occurrence word data in descending order of the number of appearances associated with each of the co-occurrence words, and outputs the co-occurrence words up to a predetermined upper rank to the search query acquisition unit 52.

The intermediate data storage unit 20 stores at least co-occurrence word data. In a case where the document data processing device 1b includes the vectorization unit 13, the similarity calculation unit 14, and the grouping unit 15, and the word extraction unit 12a includes the configuration of the word extraction unit 12, the intermediate data storage unit 20 stores the word data, the vector data, the similarity data, the transitivity-based group data, and the affiliated group data.

### Generation Processing Of Co-Occurrence Word Data by Document Data Processing Device 1b

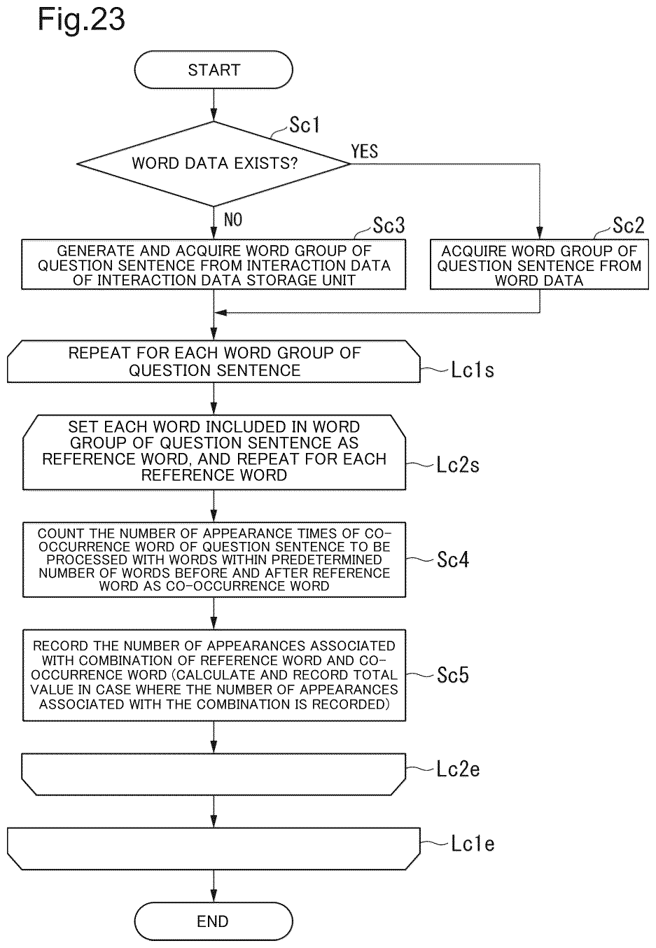

Hereinafter, processing in which the document data processing device 1b generates co-occurrence word data will be described with reference to a flowchart illustrated in FIG. 23. Here, an example of a case where an item of “question” of the interaction data is predetermined as the predetermined item will be described.

The appearance word counting unit 41 determines whether word data is stored in the intermediate data storage unit 20. In a case where it is determined that the word data is stored in the intermediate data storage unit 20 (Sc1, Yes), the appearance word counting unit 41 acquires the word group of the question sentence included in each of the word data stored in the intermediate data storage unit 20 (Sc2).

On the other hand, in a case of determining that the word data is not stored in the intermediate data storage unit 20 (Sc1, No), the appearance word counting unit 41 outputs the interaction data acquisition request signal to the acquisition unit 11a. Upon receiving the interaction data acquisition request signal from the appearance word counting unit 41, the acquisition unit 11a reads the interaction data one by one from the interaction data storage unit 2 and outputs the read interaction data to the appearance word counting unit 41. After the acquisition unit 11a acquires all the interaction data stored in the interaction data storage unit 2 and ends the output to the appearance word counting unit 41, the acquisition unit 11a outputs the completion notification signal to the appearance word counting unit 41.

Every time the appearance word counting unit 41 captures the interaction data output by the acquisition unit 11a, the appearance word counting unit outputs a word extraction request signal including character string data of a question sentence indicated in the item “question” of the captured interaction data to the word extraction unit 12a. Upon receiving the word extraction request signal from the appearance word counting unit 41, the word extraction unit 12a extracts a word from the character string data included in the received word extraction request signal, and outputs a word extraction completion signal including a word group in which the extracted words are listed to the appearance word counting unit 41. The appearance word counting unit 41 captures the word extraction completion signal output from the word extraction unit 12a, and sets a word group included in the captured word extraction completion signal as a word group of the question sentence. The appearance word counting unit 41 acquires a word group of the question sentence associated with each of the character string data of the question sentences of all the interaction data stored in the interaction data storage unit 2 by repeatedly performing the above procedure for each interaction data until receiving the completion notification signal from the acquisition unit 11a (Sc3).

The word groups of the question sentence acquired by the appearance word counting unit 41 by the processing of Sc2 and Sc3 are all the word groups extracted by the word extraction units 12 and 12a from the character string data of the question sentence associated with each predetermined item of the interaction data stored in the interaction data storage unit 2, that is, the item of “question”, and have the same contents.

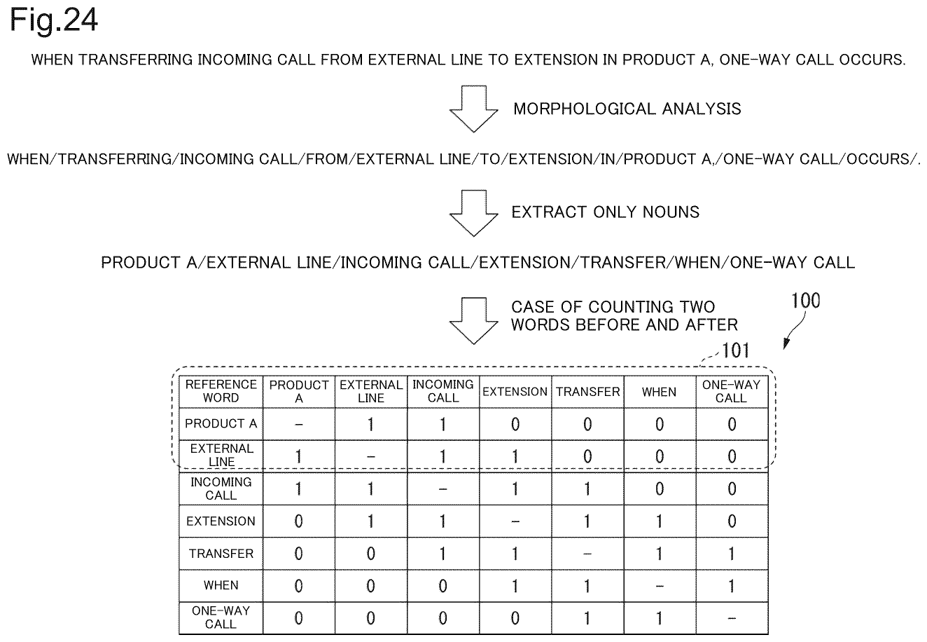

The appearance word counting unit 41 selects a word group of any one question sentence from the word group of the question sentence obtained by the processing of Sc2 or the processing of Sc3, and selects each of the words included in the word group of the selected question sentence as a reference word. For example, as illustrated in FIG. 24, it is assumed that the character string data of the question sentence when the word group of the question sentence selected by the appearance word counting unit 41 is obtained is “When transferring an incoming call from an external line to an extension in the product A, a one-way call occurs.”. It is assumed that “product A/external line/incoming call/extension/transfer/when/one-way call” is obtained as a word group of the question sentence from the character string data of the question sentence.

The appearance word counting unit 41 sets each of the words of the word group of the selected question sentence as a reference word.

For example, it is assumed that the appearance word counting unit 41 first uses the word of “product A” in the word group of the question sentence as the reference word. The appearance word counting unit 41 sets a word existing within a predetermined number of words before and after the reference word “product A” as a co-occurrence word of the reference word, and counts the number of appearances of the co-occurrence words within the predetermined number of words before and after the reference word. Here, it is assumed that, for example, “2” is predetermined as the predetermined number of words. In this case, the appearance word counting unit 41 counts the number of appearances of each of the words “external line” and “incoming call” existing within two words before and after “product A” as a co-occurrence word of the reference word “product A” and counts the number of appearances of each of the words “external line” and “incoming call” as “1”. The appearance word counting unit 41 generates data in which “external line” and “incoming call” are associated as co-occurrence words with respect to “product A” which is a reference word, the number of appearances “1” is associated with the co-occurrence word “external line”, and the number of appearances “1” is associated with the co-occurrence word “incoming call”. The appearance word counting unit 41 outputs the generated data and the word group “product A/external line/incoming call/extension/transfer/when/one-way call” of the selected question sentence to the co-occurrence word data generation unit 42 (Sc4).

The co-occurrence word data generation unit 42 takes in the data output from the appearance word counting unit 41 and the word group of the question sentence, and generates a portion indicated by reference numeral 101 in the co-occurrence word data table (hereinafter, referred to as a co-occurrence word data table 100) indicated by reference numeral 100 in FIG. 24 in the intermediate data storage unit 20 based on the taken data and the word group of the question sentence. In the generation of the co-occurrence word data table 100, the co-occurrence word data generation unit 42 records “-” indicating a blank in the item of the column associated with the word of “product A” which is the reference word indicated in the captured data. The co-occurrence word data generation unit 42 records the number of appearances “1” associated with each of the co-occurrence words “external line” and “incoming call” in the item of the column associated with each of the co-occurrence words, and records “0” in the item of the column associated with the words “extension”, “transfer”, “when”, and “one-way call” included in the word group of the question sentence other than the co-occurrence words “external line” and “incoming call” (Sc5).

The appearance word counting unit 41 and the co-occurrence word data generation unit 42 similarly perform the processing of Sc4 and Sc5 on words other than “product A” in the word group of the selected question sentence (loops Lc2s to Lc2e). In this repetitive processing, records in the second to seventh rows of the co-occurrence word data table 100 are generated. In the co-occurrence word data table 100, the record of each row is co-occurrence word data associated with each reference word.

The appearance word counting unit 41 and the co-occurrence word data generation unit 42 perform the processing of the loops Lc2s to Lc2eon each of the word groups of the other question sentences (loops Lc1s to Lc1e). In performing the processing of Sc5 by the appearance word counting unit 41 on the word group of the question sentence selected for the second and subsequent times, some co-occurrence word data is already stored in the co-occurrence word data table 100 of the intermediate data storage unit 20. Therefore, in the processing of Sc5, in a case where the combination of the reference word, the co-occurrence word, and the number of appearances output from the appearance word counting unit 41 by the second and subsequent processing of Sc4 is acquired, the co-occurrence word data generation unit 42 determines whether the co-occurrence word data associated with the acquired combination of the reference word exists in a co-occurrence word data table 100.

It is assumed that the co-occurrence word data generation unit 42 determines that co-occurrence word data associated with the reference word of the combination does not exist in the co-occurrence word data table 100. In this case, the co-occurrence word data generation unit 42 adds the record for the reference word, that is, the co-occurrence word data to the co-occurrence word data table 100, and records the number of appearances of the combination in the column of the co-occurrence word of the combination of the added co-occurrence word data.

It is assumed that the co-occurrence word data generation unit 42 determines that co-occurrence word data associated with the reference word of the combination exists in the co-occurrence word data table 100. In this case, the co-occurrence word data generation unit 42 selects the co-occurrence word data in the co-occurrence word data table 100. In a case where there is a column associated with the co-occurrence words of the combination in the selected co-occurrence word data, the co-occurrence word data generation unit 42 calculates a total value of the number of appearances indicated in the column and the number of appearances of the combination, and records the calculated total value as the number of appearances of the column. In a case where there is no column associated with the co-occurrence word of the combination in the selected co-occurrence word data, the co-occurrence word data generation unit 42 adds a column associated with the co-occurrence word and records the number of appearances of the combination in the added column.

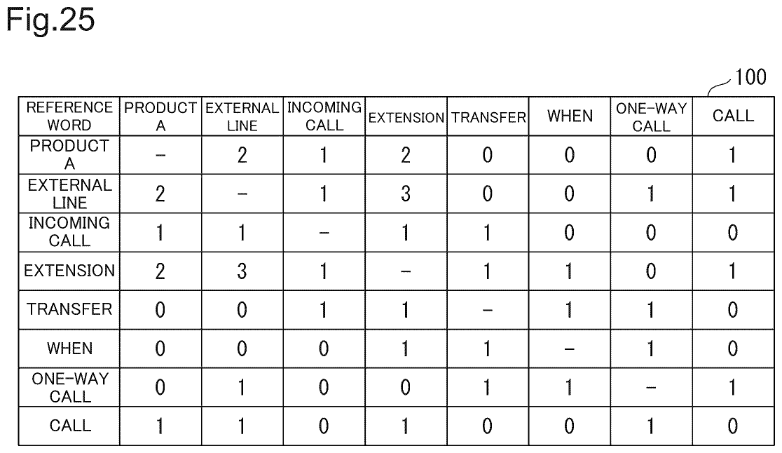

For example, it is assumed that, as the second processing of the loops Lc1s to Lc1e, processing for the word group “product A/extension/external line” of the question sentence obtained from the character string data “In the product A, the extension is connected, but the external line is not connected.” of the question sentence is performed. Further, as the third processing, it is assumed that processing for the word group “product A/extension/call/external line/one-way call” of the question sentence obtained from the character string data “In the product A, an extension can be used for a call, but an external line is a one-way call.” of the question sentence is performed. In this case, the content of the co-occurrence word data table 100 stored in the intermediate data storage unit 20 is the content illustrated in FIG. 25.

After the co-occurrence word data generation unit 42 ends the processing of Sc5 for the last reference word in the word group of the last question sentence, the processing of the loops Lc1s to Lc1e is also ended, and the processing illustrated in FIG. 23 is ended.

### Display Processing of Co-Occurrence Word by Document Data Processing Device 1b

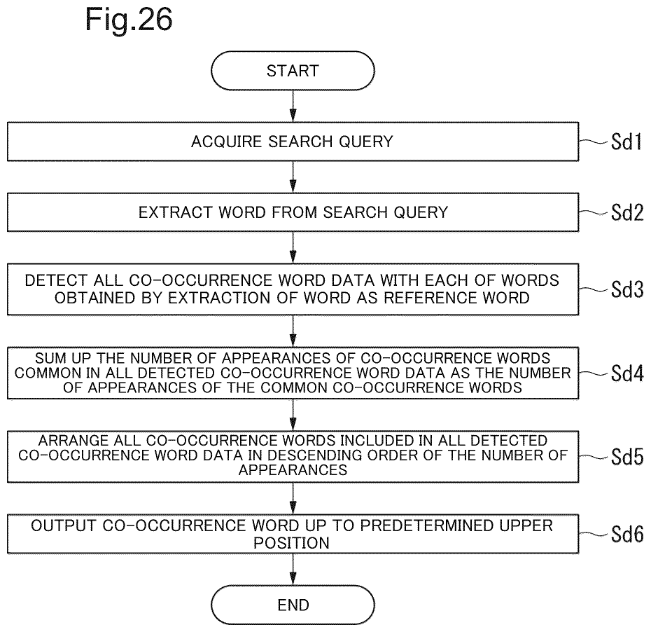

Hereinafter, processing in which the document data processing device 1b displays the co-occurrence word using the co-occurrence word data stored in the intermediate data storage unit 20 will be described. FIG. 26 is a flowchart illustrating a flow of processing by the co-occurrence word recommendation unit 54.

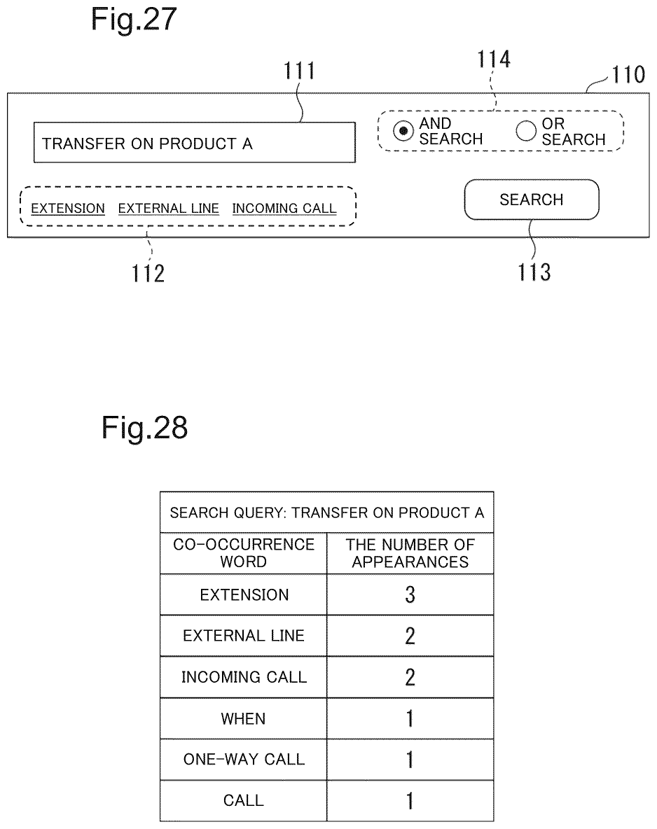

For example, the search query acquisition unit 52 displays, on the output device 3, a search query input screen 110 illustrated in FIG. 27 in which a search query input frame (hereinafter, referred to as a search query input frame 111) indicated by reference numeral 111 is blank and nothing is displayed in a region indicated by reference numeral 112. After the user performs an operation of writing a character string in the search query input frame 111 of the search query input screen 110 on the input device 4, the input device 4 outputs character string data of the written character string to the search query acquisition unit 52. Upon capturing the character string data output from the input device 4, the search query acquisition unit 52 displays the captured character string data in the search query input frame 111. The search query acquisition unit 52 outputs the character string data displayed in the search query input frame 111 to the co-occurrence word recommendation unit 54 as a search query.

The co-occurrence word recommendation unit 54 captures the search query output by the search query acquisition unit 52 (Sd1). The co-occurrence word recommendation unit 54 outputs a word extraction request signal including the captured search query to the word extraction unit 12a. Upon receiving the word extraction request signal from the co-occurrence word recommendation unit 54, the word extraction unit 12a extracts a word from the search query included in the received word extraction request signal, and outputs a word extraction completion signal including a word group in which the extracted words are listed to the co-occurrence word recommendation unit 54. The co-occurrence word recommendation unit 54 captures a word extraction completion signal output from the word extraction unit 12a (Sd2). The co-occurrence word recommendation unit 54 detects all the co-occurrence word data having each of the words indicated in the word group included in the taken word extraction completion signal as a reference word from the co-occurrence word data table 100 of the intermediate data storage unit 20 (Sd3).

For example, it is assumed that the character string written in the search query input frame 111 is “transfer in product A”, and the content of the co-occurrence word data table 100 stored in the intermediate data storage unit 20 is the content illustrated in FIG. 25. In this case, the co-occurrence word recommendation unit 54 captures, in the processing of Sd2, a word extraction completion signal including a word group in which each of the words “product A” and “transfer” extracted by the word extraction unit 12a from the character string “transfer in product A” is listed. In the processing of Sd3, the co-occurrence word recommendation unit 54 detects, as co-occurrence word data of the reference words “product A” and “transfer”, a record of the co-occurrence word data table 100 in which each of the words “product A” and “transfer” in the word group included in the captured word extraction completion signal is used as a reference word. Here, the co-occurrence word recommendation unit 54 detects a record in the first row of the co-occurrence word data table 100 as co-occurrence word data of the reference word “product A”, and detects a record in the fifth row of the co-occurrence word data table 100 as co-occurrence word data of the reference word “transfer”.

The co-occurrence word recommendation unit 54 sets the total number obtained by summing the number of appearances of common co-occurrence words in all the detected co-occurrence word data as the number of appearances of the common co-occurrence words (Sd4). The co-occurrence word recommendation unit 54 arranges each of the co-occurrence words included in all the detected co-occurrence word data in descending order of the number of appearances associated with each of the co-occurrence words (Sd5).

The content of the co-occurrence word data detected for each of the reference words “product A” and “transfer” by the co-occurrence word recommendation unit 54 is described in the form of “co-occurrence word/number of appearances” as follows. The reference word “product A” is “external line/2”, “incoming call/1”, “extension/2”, and “call/1”. A reference word “transfer” is “incoming call/1”, “extension/1”, “when/1”, and “one-way call/1”. Since the word having the number of appearances of “0” is not a co-occurrence word, the co-occurrence word recommendation unit 54 does not arrange the word. In a case where any one of the reference words is included in the co-occurrence word, the co-occurrence word recommendation unit 54 excludes the co-occurrence word. In a case where the co-occurrence word recommendation unit 54 calculates the total value for the number of appearances of the common co-occurrence words, and then arranges the common co-occurrence words in descending order of the number of appearances, as illustrated in FIG. 28, “extension/3”, “external line/2”, “incoming call/2”, “when/1”, “one-way call/1”, and “call/1” are arranged in this order.

The co-occurrence word recommendation unit 54 selects co-occurrence words up to a predetermined upper position in the arrangement of co-occurrence words, outputs the selected co-occurrence words to the search query acquisition unit 52 (Sd6), and ends the processing. Here, it is assumed that, for example, “3” is predetermined as the upper predetermined position. In this case, the co-occurrence word recommendation unit 54 arranges the top three co-occurrence words in descending order of the number of appearances to generate word lists of “extension”, “external line”, and “incoming call”, and outputs the generated word list to the search query acquisition unit 52. Upon capturing the word list output by the co-occurrence word recommendation unit 54, the search query acquisition unit 52 displays three words arranged in the order of “extension”, “external line”, and “incoming call” indicated in the captured word list on a search query input screen 110 displayed on the output device 3 as indicated by reference numeral 112 in FIG. 27.

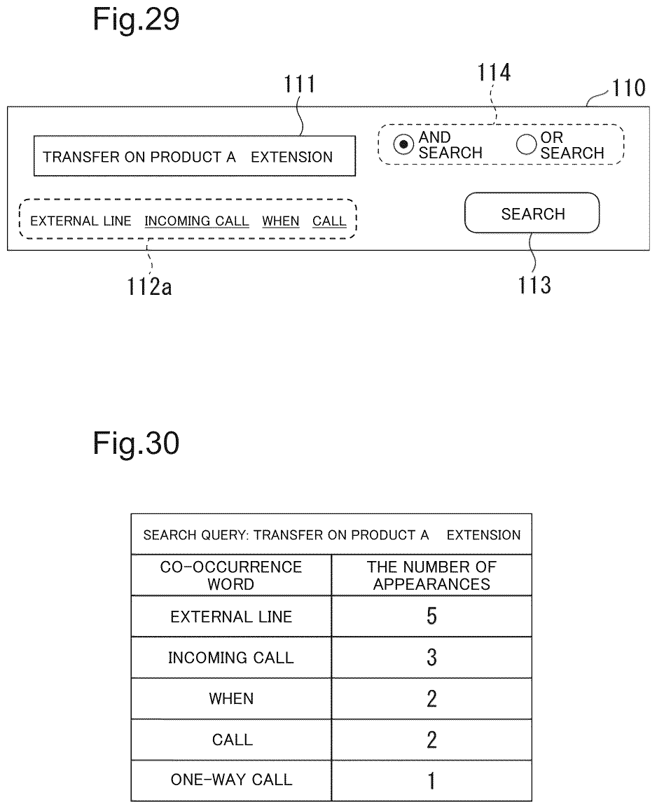

It is assumed that three co-occurrence words “extension”, “external line”, and “incoming call” displayed as indicated by reference numeral 112 are displayed in a state selectable by the user, and the user performs an operation to select “extension” on input device 4. In this case, the input device 4 outputs a search query addition signal including the selected word “extension” to the search query acquisition unit 52. The search query acquisition unit 52 captures a search query addition signal including the word “extension” output from the input device 4. In a case where the search query acquisition unit 52 captures the search query addition signal, as illustrated in FIG. 29, the search query acquisition unit adds a space to the already displayed “transfer with product A” and then adds and displays the word “extension” included in the captured search query addition signal in the search query input frame 111. The search query acquisition unit 52 outputs “transfer extension in product A”, which is the character string data displayed in the search query input frame 111, to the co-occurrence word recommendation unit 54 as a search query.

The co-occurrence word recommendation unit 54 performs the processing of Sd2 on the search query output by the search query acquisition unit 52, thereby acquiring three words “product A”, “transfer”, and “extension” from the word extraction completion signal output by the word extraction unit 12a. In the processing of Sd3, the co-occurrence word recommendation unit 54 detects records in the first, fifth, and fourth rows of the co-occurrence word data table 100 having each of “product A”, “transfer”, and “extension” as a reference word as co-occurrence word data of the reference words “product A”, “transfer”, and “extension”.

Here, the content of the co-occurrence word data of the reference word “extension” is “product A/2”, “external line/3”, “incoming call/1”, “transfer/1”, “when/1”, and “call/1”. In the processing of Sd4, the co-occurrence word recommendation unit 54 calculates a total value of the number of appearances of co-occurrence words common in the three co-occurrence word data. In this case, “external line”, “incoming call”, “extension”, “when”, and “call” are common. However, since “extension” is a reference word, the co-occurrence word recommendation unit 54 calculates a total value “5” for “external line”, calculates a total value “3” for “incoming call”, calculates a total value “2” for “when”, and calculates a total value “2” for “call”, while excluding “extension”.

In the processing of Sd5, the co-occurrence word recommendation unit 54 arranges all the co-occurrence words “external line”, “incoming call”, “when”, “one-way call”, and “call” in the detected three co-occurrence word data in descending order of the number of appearances except for the number of appearances associated with the reference words “product A”, “transfer”, and “extension”. In this case, as illustrated in FIG. 30, the co-occurrence word recommendation unit 54 arranges “external line/5”, “incoming call/3”, “when/2”, “call/2”, and “one-way call/1” in this order. In the processing of Sd6, the co-occurrence word recommendation unit 54 arranges the co-occurrence words from the top three in descending order of the number of appearances to generate word lists of “external line”, “incoming call”, “when”, and “call”, and outputs the generated word list to the search query acquisition unit 52. The search query acquisition unit 52 captures the word list output by the co-occurrence word recommendation unit 54. The search query acquisition unit 52 displays, on the search query input screen 110 displayed on the output device 3, four co-occurrence words arranged in the order of “external line”, “incoming call”, “when”, and “call” indicated in the word list, as indicated by reference numeral 112a in FIG. 29, instead of displaying the co-occurrence words indicated by reference numeral 112 in FIG. 27.

In a state where the search query input screen 110 illustrated in FIG. 29 is displayed on the output device 3, for example, it is assumed that the user performs an operation of selecting a radio button associated with the AND search in a portion indicated by reference numeral 114 and further selecting the search button 113 on the input device 4. The input device 4 outputs a search request signal including the search condition indicating the AND search and the search query which is the character string data of the “transfer extension in product A” displayed in the search query input frame 111 to the search processing unit 53. Upon receiving the search request signal from the input device 4, the search processing unit 53 divides the character string data indicated by the search query included in the search request signal by spaces into two pieces of character string data “transfer in product A” and “extension”. According to the AND search as a search condition included in the search request signal, the search processing unit 53 detects, from the interaction data storage unit 2, interaction data including character string data of each of “transfer in product A” and “extension” at any position in the character string data of the question sentence indicated in the item “question” of the interaction data. The search processing unit 53 outputs the detected interaction data to the output device 3.

### Effects of Document Data Processing Device 1b

By searching the interaction data storage unit 2 using more appropriate words, it is possible to detect interaction data with a high accuracy rate, that is, a more appropriate answer. On the other hand, in a first-reception contact center or the like, it is necessary to quickly answer the questioner, and the time required to examine the content to be answered is limited. Therefore, there is a circumstance that the number of words included in the search word that can be conceived when the answerer searches the past interaction data is about several words. In such a case, by using the document data processing device 1b, co-occurrence word data can be generated in advance from the interaction data, and a word that frequently appears together with a word included in a search word conceived by the answerer in the interaction data can be presented to the answerer as a co-occurrence word based on the generated co-occurrence word data. Therefore, even if the search word conceived by the answerer does not have an information amount sufficient to obtain the desired interaction data, the information amount can be compensated by adding and searching the co-occurrence word presented by the answerer, whereby the probability that the desired interaction data can be obtained can be improved without deteriorating the search accuracy, and a more appropriate answer can be given to the questioner.

### Other Configuration Examples of Document Data Processing Device 1b

In the document data processing device 1b, the predetermined item predetermined in the appearance word counting unit 41 is set as the item of “question”, but the predetermined item may be the item of “answer”, or the predetermined item may be both the item of “question” and the item of “answer”.

Although the example in which the predetermined number of words determined in advance is “2” has been described in the appearance word counting unit 41 of the document data processing device 1b, the predetermined number of words may be any value as long as it is an integer value of 1 or more. The appearance word counting unit 41 may count the number of appearances of all the words existing before and after the reference word as co-occurrence words by setting the predetermined number of words to, for example, the maximum number of characters that can be written in the item.

In the co-occurrence word recommendation unit 54 of the document data processing device 1b, an example in which the predetermined upper predetermined position determined in advance is “3” has been described, but the predetermined position may have any value as long as the value is an integer value of 1 or more. The co-occurrence word recommendation unit 54 may use any method as long as it is a method of selecting a co-occurrence word based on the number of appearances, for example, selecting a co-occurrence word having the number of appearances equal to or more than a predetermined constant value to generate a word list.

In the document data processing device 1b, when the processing of the loops Lc1s to Lc1e illustrated in FIG. 23 is finished, the co-occurrence word data generation unit 42 may count the number of pieces of interaction data to be processed, and rewrite a value obtained by dividing the number of appearances associated with each of the co-occurrence words indicated in each piece of the co-occurrence word data by the counted number of pieces of interaction data as the number of appearances of the co-occurrence words. This makes it possible to perform commonization of the scale of the number of appearances for each co-occurrence word, that is, simple normalization, such as weakening the influence when a large number of certain words appear in a specific sentence of the interaction data.

In the document data processing device 1b, the search processing unit 53 performs a search for the interaction data stored in the interaction data storage unit 2. However, for example, the search processing unit may perform a search for any system or device in which information related to the interaction data is accumulated, such as a search for an AI or machine learning system trained with the interaction data stored in the interaction data storage unit 2 as training data, or a search with a device disclosed in JP 2024-132249 A.

The configuration of the document data processing device 1b may be such that the intermediate data storage unit 20 does not store in advance the word data generated by the document data processing devices 1 and 1a, and the appearance word counting unit 41 starts from the processing of Sc3 without performing the processing of Sc1 and Sc2 of FIG. 23.

That is, the document data processing device 1b may exist as a completely independent device from the document data processing devices 1 and 1a.

### Another Configuration Example Common to Document Data Processing Devices 1, 1a, and 1b

Although the document data processing devices 1, 1a, and 1b perform the processing for the interaction data illustrated in FIG. 2, the document data processing devices 1, 1a, and 1b may perform the above-described processing for any document data other than the interaction data, the document data including at least an item of “case ID” and one or more items indicating character string data, and character string data indicated in any item of the document data instead of the item of “question” or “answer”.

### Hardware Configuration

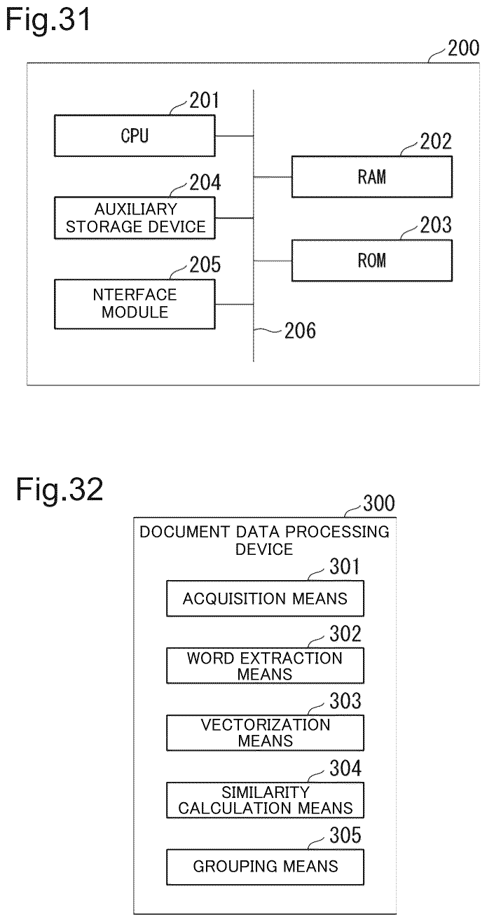

FIG. 31 is a diagram illustrating an example of a hardware configuration of the document data processing devices 1, 1a, and 1b according to the present disclosure. The document data processing devices 1, 1a, and 1b according to the present disclosure are, for example, computers including a central processing unit (CPU) 201, a random access memory (RAM) 202, a read only memory (ROM) 203, an auxiliary storage device 204, and an interface module 205. The CPU 201, the RAM 202, the ROM 203, the auxiliary storage device 204, and the interface module 205 are mutually connected by a bus 206. The auxiliary storage device 204 is, for example, a hard disk drive (HDD), a solid state drive (SSD), or the like. The interaction data storage unit 2, the output device 3, and the input device 4 are connected to the interface module 205.

The acquisition units 11 and 11a, the word extraction units 12 and 12a, the vectorization unit 13, the similarity calculation units 14 and 14a, the high similarity data selection unit 16, the transitivity-based group determination unit 17, the community detection unit 18, the group coupling adjustment unit 19, the group representative data generation unit 31, the group feature analysis unit 32, the appearance word counting unit 41, the co-occurrence word data generation unit 42, the search query acquisition unit 52, the search processing unit 53, and the co-occurrence word recommendation unit 54 are configured by the CPU 201 executing the application program stored in advance in the ROM 203 or the auxiliary storage device 204, and the storage area of the intermediate data storage unit 20 is secured in the RAM 202 or the auxiliary storage device 204.

### Fourth Example Embodiment

Hereinafter, one example embodiment according to the present disclosure will be described with reference to the drawings. As illustrated in FIG. 32, the document data processing device 300 includes acquisition means 301 for acquiring document data including one or more items, word extraction means 302 for extracting a word from character string data indicated in the item of the document data, vectorization means 303 for vectorizing each piece of the character string data based on the word for each piece of the character string data, similarity calculation means 304 for calculating similarity between the pieces of the character string data having the same item, based on a vector associated with each piece of the character string data, and grouping means 305 for selecting the document data having a direct and indirect coupling relationship based on the similarity and a predetermined similarity threshold, and grouping each of the combinations having the coupling relationship to be selected.

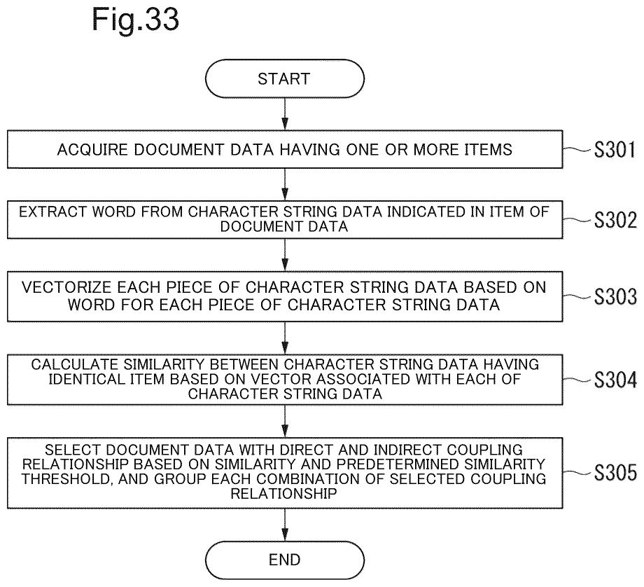

As illustrated in FIG. 33, the acquisition means 301 acquires document data including one or more items (S301). The word extraction means 302 extracts a word from the character string data indicated in the item of the document data acquired by the acquisition means 301 (S302). The vectorization means 303 vectorizes each piece of character string data based on the word for each piece of character string data extracted by the word extraction means 302 (S303). The similarity calculation means 304 calculates similarity between pieces of character string data having the same item based on vectors associated with the pieces of character string data (S304). The grouping means 305 selects document data having a direct and indirect coupling relationship based on the similarity calculated by the similarity calculation means 304 and a predetermined similarity threshold, and groups each combination having the selected coupling relationship (S305).

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

Some or all of the above example embodiments may be described as the following Supplementary Notes, but are not limited to the following.
(Supplementary Note 1) A document data processing device includes acquisition means (for example, acquisition units 11, 11a) for acquiring document data (for example, interaction data) including one or more items, word extraction means (for example, word extraction units 12, 12a) for extracting a word from character string data indicated in the item of the document data, vectorization means (for example, a vectorization unit 13) for vectorizing each piece of the character string data based on the word for each piece of the character string data, similarity calculation means (for example, similarity calculation units 14, 14a) for calculating similarity between the pieces of the character string data having the same item, based on a vector associated with each piece of the character string data, and grouping means (for example, a grouping unit 15) for selecting the document data having a direct and indirect coupling relationship based on the similarity and a predetermined similarity threshold, and grouping each of combinations having the coupling relationship to be selected (for example, a transitivity-based group or an affiliated group).
(Supplementary Note 2) The document data processing device according to (Supplementary Note 1), further including group representative data generation means (for example, group representative data generation unit 31) for generating the document data as a representative for each of the groups from the document data belonging to each of the groups.
(Supplementary Note 3) The document data processing device according to (Supplementary Note 1) or (Supplementary Note 2), further including group feature analysis means (for example, group feature analysis unit 32) for calculating a centroid vector of each of the groups, and calculating a distance between the groups and a contribution degree of a word common between the groups based on the calculated centroid vector.
(Supplementary Note 4) The document data processing device according to any one of (Supplementary Note 1) to (Supplementary Note 3), further including group coupling adjustment means (for example, group coupling adjustment unit 19), in which the acquisition means acquires increment document data (for example, increment interaction data) that is the document data to be added, the word extraction means extracts a word from the character string data indicated in the item of the increment document data, the vectorization means vectorizes each piece of the character string data based on the word of each piece of the character string data extracted from the increment document data by the word extraction means, the similarity calculation means (for example, similarity calculation unit 14a) calculates similarity between the pieces of the character string data having the same item based on a vector associated with each piece of character string data of the increment document data, and calculates similarity between the pieces of the character string data of the increment document data and the pieces of the character string data of an existing document data having the same item based on a vector associated with each piece of the character string data of the increment document data and a vector associated with each piece of the character string data of the existing document data that is the document data before the increment document data is added, the grouping means selects, based on the similarity and the similarity threshold, the increment document data and the existing document data having a direct and indirect coupling relationship, and sets each of combinations having the coupling relationship to be selected as an increment group (for example, increment transitivity-based group), and the group coupling adjustment means detects, for each piece of the increment document data belonging to the increment group, the number of couplings between the increment document data and the group (for example, increment transitivity-based group) formed by the existing document data and the number of couplings in the increment group indicated by the number of other increment document data to which the increment document data is coupled, selects a destination to which each piece of the increment document data belongs based on the number of couplings to be detected and the group formed by the existing document data, and regroups the group formed by the existing document data and the increment group according to the selection.
(Supplementary Note 5) The document data processing device according to any one of (Supplementary Note 1) to (Supplementary Note 4), in which the grouping means regroups the groups by dividing the groups by community detection for each of the groups.
(Supplementary Note 6) The document data processing device according to any one of (Supplementary Note 1) to (Supplementary Note 5), further including:
   appearance word counting means (for example, an appearance word counting unit 41) for selecting each of the words indicated in a word group including words extracted from the character string data associated with a predetermined item predetermined by the word extraction means as a reference word, setting words existing before and after the reference word as co-occurrence words of the reference word for each word group of a selection source of the reference word, and counting the number of appearances of the co-occurrence words in the word group; and co-occurrence word data generation means (for example, a co-occurrence word generation unit 42) for generating, for a combination of the reference word and the co-occurrence words associated with the reference word, co-occurrence word data by associating a total value of the number of appearances counted for each of the word groups by the appearance word counting means with the combination of the reference word and the co-occurrence words.
(Supplementary Note 7) The document data processing device according to (Supplementary Note 6) further including search query acquisition means (for example, a search query acquisition unit 52) for acquiring a search query given from an outside; and
   co-occurrence word recommendation means (for example, a co-occurrence word recommendation unit 54) for detecting the co-occurrence word data having each of the words indicated by the search query as the reference word, and in a case where the co-occurrence words common to the detected co-occurrence word data are included, setting a total value of the number of appearances of the common co-occurrence words as the number of appearances of the common co-occurrence words, and outputting each of the co-occurrence words included in the detected co-occurrence word data according to the number of appearances.
(Supplementary Note 8) The document data processing device according to (Supplementary Note 7), in which the co-occurrence word recommendation means, in a case where any of the co-occurrence words output by the co-occurrence word recommendation means is selected, detects the co-occurrence word data in which each of the words indicated by the search query and the co-occurrence words to be selected is set as the reference word.
(Supplementary Note 9) A document data processing method including: acquiring document data including one or more items; extracting a word from character string data indicated in the item of the acquired document data; vectorizing each piece of the character string data based on the word for each piece of the extracted character string data; calculating similarity between the pieces of the character string data having the same item, based on a vector associated with each piece of the character string data; and selecting the document data having a direct and indirect coupling relationship based on the calculated similarity and a predetermined similarity threshold, and grouping each of combinations having the selected coupling relationship.
(Supplementary Note 10) The document data processing method according to (Supplementary Note 9), further including generating the document data as a representative for each of the groups from the document data belonging to each of the groups.
(Supplementary Note 11) The document data processing method according to (Supplementary Note 9) or (Supplementary Note 10), further including calculating a centroid vector of each of the groups, and calculating a distance between the groups and a contribution degree of a word common between the groups based on the calculated centroid vector.
(Supplementary Note 12) The document data processing method according to any one of (Supplementary Note 9) to (Supplementary Note 11), further acquiring increment document data that is the document data to be added, extracting a word from the character string data indicated in the item of the acquired increment document data, vectorizing each piece of the character string data based on the word of each piece of the extracted character string data, calculating similarity between the pieces of the character string data having the same item based on a vector associated with each piece of character string data of the increment document data, and calculating similarity between the pieces of the character string data of the increment document data and the pieces of the character string data of the existing document data having the same item based on a vector associated with each piece of the character string data of the increment document data and a vector associated with each piece of the character string data of the existing document data that is the document data before the increment document data is added, selecting, based on the calculated similarity and the similarity threshold, the increment document data and the existing document data having a direct and indirect coupling relationship, and setting each of combinations having the selected coupling relationship as an increment group, and detecting, for each piece of the increment document data belonging to the increment group, the number of couplings between the increment document data and the group formed by the existing document data and the number of couplings in the increment group indicated by the number of other increment document data to which the increment document data is coupled, selecting a destination to which each piece of the increment document data belongs based on the number of couplings to be detected and the group formed by the existing document data, and regrouping the group formed by the existing document data and the increment group according to the selection.
(Supplementary Note 13) The document data processing method according to any one of (Supplementary Note 9) to (Supplementary Note 12), in which the grouping means regroups the groups by dividing the groups by community detection for each of the groups.
(Supplementary Note 14) The document data processing method according to any one of (Supplementary Note 9) to (Supplementary Note 13), further including: selecting each of the words indicated in a word group including words extracted from the character string data associated with a predetermined item predetermined as a reference word, setting words existing before and after the reference word as co-occurrence words of the reference word for each word group of a selection source of the selected reference word, and counting the number of appearances of the co-occurrence words in the word group; and generating, for a combination of the reference word and the co-occurrence words associated with the reference word, co-occurrence word data by associating a total value of the number of appearances counted for each of the word groups in association with the combination of the reference word with the co-occurrence words.
(Supplementary Note 15) The document data processing method according to (Supplementary Note 14), further including acquiring a search query given from an outside; and detecting the co-occurrence word data having each of the words indicated by the acquired search query as the reference word, and in a case where the co-occurrence words common to the detected co-occurrence word data are included, setting a total value of the number of appearances of the common co-occurrence words as the number of appearances of the common co-occurrence words, and outputting each of the co-occurrence words included in the detected co-occurrence word data according to the number of appearances.
(Supplementary Note 16) The document data processing method according to (Supplementary Note 15), in a case where any one of the output co-occurrence words is selected, further detecting the co-occurrence word data in which each of the words indicated by the search query and the selected co-occurrence words is set as the reference word.
(Supplementary Note 17) A program causing a computer to function as
   acquisition means for acquiring document data including one or more items; word extraction means for extracting a word from character string data indicated in the item of the document data; vectorization means for vectorizing each piece of the character string data based on the word for each piece of the character string data; similarity calculation means for calculating similarity between the pieces of the character string data having the same item, based on a vector associated with each piece of the character string data; and grouping means for selecting the document data having a direct and indirect coupling relationship based on the similarity and a predetermined similarity threshold, and grouping each of combinations having the coupling relationship to be selected.
(Supplementary Note 18) The program according to (Supplementary Note 17), further functioning as group representative data generation means for generating the document data as a representative for each of the groups from the document data belonging to each of the groups.
(Supplementary Note 19) The program according to (Supplementary Note 17) or (Supplementary Note 18), further functioning as group feature analysis means for calculating a centroid vector of each of the groups, and calculating a distance between the groups and a contribution degree of a word common between the groups based on the calculated centroid vector.
(Supplementary Note 20) The program according to any one of (Supplementary Note 17) to (Supplementary Note 19), further functioning as group coupling adjustment means, in which the acquisition means acquires increment document data that is the document data to be added, the word extraction means extracts a word from the character string data indicated in the item of the increment document data, the vectorization means vectorizes each piece of the character string data based on the word of each piece of the character string data extracted from the increment document data by the word extraction means, the similarity calculation means calculates similarity between the pieces of the character string data having the same item based on a vector associated with each piece of character string data of the increment document data, and calculates similarity between the pieces of the character string data of the increment document data and the pieces of the character string data of an existing document data having the same item based on a vector associated with each piece of the character string data of the increment document data and a vector associated with each piece of the character string data of the existing document data that is the document data before the increment document data is added, the grouping means selects, based on the similarity and the similarity threshold, the increment document data and the existing document data having a direct and indirect coupling relationship, and sets each of combinations having the coupling relationship to be selected as an increment group, and the group coupling adjustment means detects, for each piece of the increment document data belonging to the increment group, the number of couplings between the increment document data and the group formed by the existing document data and the number of couplings in the increment group indicated by the number of other increment document data to which the increment document data is coupled, selects a destination to which each piece of the increment document data belongs based on the number of couplings to be detected and the group formed by the existing document data, and regroups the group formed by the existing document data and the increment group according to the selection.
(Supplementary Note 21) The program according to any one of (Supplementary Note 17) to (Supplementary Note 20), in which the grouping means regroups the groups by dividing the groups by community detection for each of the groups.
(Supplementary Note 22) The program according to any one of (Supplementary Note 17) to (Supplementary Note 21), further functioning as appearance word counting means for selecting each of the words indicated in a word group including words extracted from the character string data associated with a predetermined item predetermined by the word extraction means as a reference word, setting words existing before and after the reference word as co-occurrence words of the reference word for each word group of a selection source of the reference word, and counting the number of appearances of the co-occurrence words in the word group; and co-occurrence word data generation means for generating, for a combination of the reference word and the co-occurrence words associated with the reference word, co-occurrence word data by associating a total value of the number of appearances counted for each of the word groups by the appearance word counting means with the combination of the reference word and the co-occurrence words.
(Supplementary Note 23) The program according to (Supplementary Note 22), further functioning as: search query acquisition means for acquiring a search query given from an outside; and co-occurrence word recommendation means for detecting the co-occurrence word data having each of the words indicated by the search query as the reference word, and in a case where the co-occurrence words common to the detected co-occurrence word data are included, setting a total value of the number of appearances of the common co-occurrence words as the number of appearances of the common co-occurrence words, and outputting each of the co-occurrence words included in the detected co-occurrence word data according to the number of appearances.
(Supplementary Note 24) The program according to (Supplementary Note 23), in which the co-occurrence word recommendation means, in a case where any of the co-occurrence words output by the co-occurrence word recommendation means is selected, detects the co-occurrence word data in which each of the words indicated by the search query and the co-occurrence words to be selected is set as the reference word.
(Supplementary Note 25) A document data processing device including: acquisition means (for example, an acquisition unit 11a) for acquiring document data; word extraction means (for example, an acquisition unit 11a) for extracting words from character string data included in the document data and generating a word group for each piece of the character string data; appearance word counting means (for example, an appearance word counting unit 41) for selecting each of the words included in the word group as a reference word, setting words existing before and after the reference word as co-occurrence words of the reference word for each word group of a selection source of the reference word, and counting the number of appearances of the co-occurrence words in the word group; and co-occurrence word data generation means (for example, a co-occurrence word generation unit 42) for generating, for a combination of the reference word and the co-occurrence words associated with the reference word, co-occurrence word data by associating a total value of the number of appearances counted for each of the word groups by the appearance word counting means with the combination of the reference word and the co-occurrence words.
(Supplementary Note 26) A document data processing method including: acquiring document data; extracting a word from character string data included in the acquired document data to generate a word group for each piece of the character string data; selecting each of words included in the generated word group as a reference word; for each of the word groups of a selection source of the selected reference word, setting words existing before and after the reference word as co-occurrence words of the reference word, counting the number of appearances of the co-occurrence words in the word group; and generating, for a combination of the reference word and the co-occurrence words associated with the reference word, co-occurrence word data by associating a total value of the number of appearances counted for each of the word groups with the combination of the reference word and the co-occurrence words.
(Supplementary Note 27) A program causing a computer to function as acquisition means for acquiring document data; word extraction means for extracting words from character string data included in the document data to generate a word group for each piece of the character string data; appearance word counting means for selecting each of the words included in the word group generated by the word extraction means as a reference word, setting words existing before and after the reference word as co-occurrence words of the reference word for each word group of a selection source of the reference word, and counting the number of appearances of the co-occurrence words in the word group; and co-occurrence word data generation means for generating, for a combination of the reference word and the co-occurrence words associated with the reference word, co-occurrence word data by associating a total value of the number of appearances counted for each of the word groups by the appearance word counting means with the combination of the reference word and the co-occurrence words.

1. A document data processing device comprising:
at least one memory storing a set of instructions; and
at least one processor configured to execute the set of instructions to:
acquire document data including one or more items;
extract a word from character string data indicated in each of the items of the document data;
vectorize each of pieces of the character string data based on the word for each of the pieces of the character string data;
calculate similarity between the pieces of the character string data having the same item, based on a vector associated with each of the pieces of the character string data;
select a combination of the document data having a coupling relationship that is any of a direct relationship and an indirect coupling relationship based on the similarity and a predetermined similarity threshold; and
group, into a group, the selected combination having the coupling relationship.

2. The document data processing device according to claim 1, wherein
at least one processor is configured to execute the set of instructions to:
generate representative document data for the group from the document data belonging to the group.

3. The document data processing device according to claim 1, wherein
at least one processor is configured to execute the set of instructions to:
calculate a centroid vector of the group; and
calculate a distance between groups including the group and a contribution degree of a common word between the groups based on the calculated centroid vector.

4. The document data processing device according to claim 1, wherein
at least one processor is configured to execute the set of instructions to:
acquire increment document data that is the document data having been added;
extract the word from each of the pieces of the character string data each indicated in the items of the increment document data;
vectorize the pieces of the character string data based on the word of each of the pieces of the character string data extracted from the increment document data;
calculate similarity between the pieces of the character string data having the same item based on a vector associated with each of the pieces of character string data of the increment document data;
calculate similarity between one of the pieces of the character string data of the increment document data and one of the pieces of the character string data of existing document data having the same item based on a vector associated with the one the piece of the character string data of the increment document data and a vector associated with the one of the piece of the character string data of the existing document data, the existing document data being the document data existing before the increment document data is added;
select, based on the similarity and the similarity threshold, the increment document data and the existing document data having the coupling relationship that is any of the direct coupling relationship and the indirect coupling relationship;
set a selected combination having the coupling relationship as an increment group, and
detect, for each piece of the increment document data belonging to the increment group, a number of couplings between the increment document data and the group formed by the existing document data, and a number of couplings in the increment group indicated by a number of other increment document data to which the increment document data is coupled,
select a destination to which the increment document data belongs based on the detected number of couplings and the group formed by the existing document data; and
regroup the group formed by the existing document data and the increment group according to the selected destination.

5. The document data processing device according to claim 1, wherein
at least one processor is configured to execute the set of instructions to
regroup the group by dividing the group by community detection for the group.

6. The document data processing device according to claim 1, wherein
at least one processor is configured to execute the set of instructions to:
select, as a reference word, each of words included in a word group including the word extracted from the character string data associated with a predetermined item;
set words existing in front of or subsequently to the reference word as co-occurrence words of the reference word for the word group from which the reference word is selected;
count a number of appearances of the co-occurrence words in the word group; and
generate, for a combination of the reference word and the co-occurrence words associated with the reference word, co-occurrence word data by associating a total number of the number of appearances counted for the word group with the combination of the reference word and the co-occurrence words.

7. The document data processing device according to claim 6, wherein
at least one processor is configured to execute the set of instructions to:
acquire a search query given from an outside;
detect the co-occurrence word data whose the reference word is each of the words indicated by the search query;
in a case where the co-occurrence words common to the detected co-occurrence word data are included, set a total value of a number of appearances of the common co-occurrence words common to the detected co-occurrence word data as the number of appearances of the common co-occurrence words; and
output each of the co-occurrence words included in the detected co-occurrence word data according to the number of appearances.

8. The document data processing device according to claim 7, wherein
at least one processor is configured to execute the set of instructions to:
in a case where any of the co-occurrence words being output is selected, detect the co-occurrence word data in which each of the words indicated by the search query and the selected co-occurrence words is set as the reference word.

9. A document data processing method comprising:
acquiring document data including one or more items;
extracting a word from character string data indicated in each of the items of the document data;
vectorizing each of pieces of the character string data based on the word for each of the pieces of the character string data;
calculating similarity between the pieces of the character string data having the same item, based on a vector associated with each of the pieces of the character string data;
select a combination of the document data having a coupling relationship that is any of a direct relationship and an indirect coupling relationship based on the similarity and a predetermined similarity threshold; and
grouping, into a group, the selected combination having the coupling relationship.

10. The document data processing method according to claim 9, further comprising
generating representative document data for the group from the document data belonging to the group.

11. The document data processing method according to claim 9, further comprising:
calculating a centroid vector of the group; and
calculating a distance between groups including the group and a contribution degree of a common word between the groups based on the calculated centroid vector.

12. The document data processing method according to claim 9, further comprising:
acquiring increment document data that is the document data having been added;
extracting the word from each of the pieces of the character string data each indicated in the items of the increment document data;
vectorizing the pieces of the character string data based on the word of each of the pieces of the character string data extracted from the increment document data;
calculating similarity between the pieces of the character string data having the same item based on a vector associated with each of the pieces of character string data of the increment document data;
calculating similarity between one of the pieces of the character string data of the increment document data and one of the pieces of the character string data of existing document data having the same item based on a vector associated with the one the piece of the character string data of the increment document data and a vector associated with the one of the piece of the character string data of the existing document data, the existing document data being the document data existing before the increment document data is added;
selecting, based on the similarity and the similarity threshold, the increment document data and the existing document data having the coupling relationship that is any of the direct coupling relationship and the indirect coupling relationship;
setting a selected combination having the coupling relationship as an increment group, and
detecting, for each piece of the increment document data belonging to the increment group, a number of couplings between the increment document data and the group formed by the existing document data, and a number of couplings in the increment group indicated by a number of other increment document data to which the increment document data is coupled,
selecting a destination to which the increment document data belongs based on the detected number of couplings and the group formed by the existing document data; and
regrouping the group formed by the existing document data and the increment group according to the selected destination.

13. The document data processing method according to claim 9, further comprising
regrouping the group by dividing the group by community detection for the group.

14. The document data processing method according to claim 9, further comprising:
selecting, as a reference word, each of words included in a word group including the word extracted from the character string data associated with a predetermined item;
setting words existing in front of or subsequently to the reference word as co-occurrence words of the reference word for the word group from which the reference word is selected;
counting a number of appearances of the co-occurrence words in the word group; and
generating, for a combination of the reference word and the co-occurrence words associated with the reference word, co-occurrence word data by associating a total number of the number of appearances counted for the word group with the combination of the reference word and the co-occurrence words.

15. The document data processing method according to claim 14, further comprising:
acquiring a search query given from an outside;
detecting the co-occurrence word data whose the reference word is each of the words indicated by the search query;
in a case where the co-occurrence words common to the detected co-occurrence word data are included, setting a total value of a number of appearances of the common co-occurrence words common to the detected co-occurrence word data as the number of appearances of the common co-occurrence words; and
outputting each of the co-occurrence words included in the detected co-occurrence word data according to the number of appearances.

16. The document data processing method according to claim 15, further comprising
detecting, in a case where any of the co-occurrence words being output is selected, the co-occurrence word data in which each of the words indicated by the search query and the selected co-occurrence words is set as the reference word.

17. A non-transitory computer readable storage medium storing a program causing a computer to execute processing of:
acquiring document data including one or more items;
extracting a word from character string data indicated in each of the items of the document data;
vectorizing each of pieces of the character string data based on the word for each of the pieces of the character string data;
calculating similarity between the pieces of the character string data having the same item, based on a vector associated with each of the pieces of the character string data;
select a combination of the document data having a coupling relationship that is any of a direct relationship and an indirect coupling relationship based on the similarity and a predetermined similarity threshold; and
grouping, into a group, the selected combination having the coupling relationship.

18. The non-transitory computer readable storage medium according to claim 17, the program causing the computer to further execute processing of
generating representative document data for the group from the document data belonging to the group.

19. The non-transitory computer readable storage medium according to claim 17, the program causing the computer to further execute processing of:
calculating a centroid vector of the group; and
calculating a distance between groups including the group and a contribution degree of a common word between the groups based on the calculated centroid vector.

20. The non-transitory computer readable storage medium according to claim 17, the program causing the computer to further execute processing of:
acquiring increment document data that is the document data having been added;
extracting the word from each of the pieces of the character string data each indicated in the items of the increment document data;
vectorizing the pieces of the character string data based on the word of each of the pieces of the character string data extracted from the increment document data;
calculating similarity between the pieces of the character string data having the same item based on a vector associated with each of the pieces of character string data of the increment document data;
calculating similarity between one of the pieces of the character string data of the increment document data and one of the pieces of the character string data of existing document data having the same item based on a vector associated with the one the piece of the character string data of the increment document data and a vector associated with the one of the piece of the character string data of the existing document data, the existing document data being the document data existing before the increment document data is added;
selecting, based on the similarity and the similarity threshold, the increment document data and the existing document data having the coupling relationship that is any of the direct coupling relationship and the indirect coupling relationship;
setting a selected combination having the coupling relationship as an increment group, and
detecting, for each piece of the increment document data belonging to the increment group, a number of couplings between the increment document data and the group formed by the existing document data, and a number of couplings in the increment group indicated by a number of other increment document data to which the increment document data is coupled,
selecting a destination to which the increment document data belongs based on the detected number of couplings and the group formed by the existing document data; and
regrouping the group formed by the existing document data and the increment group according to the selected destination.
